(19) United States
(12) Patent Application Publication
(10) Pub. No.: US 2016/0259502 A1
(43) Pub. Date: Sep. 8, 2016

(54) Diverse emojis/emoticons

(71) Applicant: Katrina Parrott, League City, TX (US)

(72) Inventor: Katrina Parrott, League City, TX (US)

(21) Appl. No.: 15/080,533

(22) Filed: Mar. 24, 2016

Related U.S. Application Data
(63) Continuation-in-part of application No. 14/850,554, filed on Sep. 10, 2015.
Application No. 14/850,554 is a continuation-in-part of application No. 14/850,856, filed on Sep. 10, 2015, now abandoned.
(60) Provisional application No. 62/048,691, filed on Sep. 10, 2014.

(51) Int. Cl. G06F 3/0482; G06F 3/0481; G06F 3/0484; H04W 4/12

(52) U.S. Cl. CPC G06F 3/0482; H04W 4/12; G06F 3/04817; G06F 3/04842

(57) ABSTRACT

The present invention provides a method of embedding, transferring and communicating custom generated emojis/emoticons having unique physical features.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO A “MICROFICHE APPENDIX”

Not applicable

Priority of our U.S. application Ser. No. 14/850,554, filed 10 Sep. 2015 and our U.S. Provisional Patent Application Patent No. 62/048,691, filed 10 Sep. 2014, both of which are incorporated herein by reference, is hereby claimed. This is a continuation-in-part of our U.S. patent application Ser. No. 14/850,554, filed September 2015.

Priority of our U.S. application Ser. No. 14/850856, filed 10 Sep. 2015 and our U.S. Provisional Patent Application Patent No. 62/048,691, filed 10 Sep. 2014, both of which are incorporated herein by reference, is hereby claimed. This is a continuation-in-part of our U.S. patent application Ser. No. 14/850856, filed 10 Sep. 2015.

### BACKGROUND OF THE INVENTION

The present invention relates to methods and systems for generating, transferring and communicating custom emojis/emoticons. More specifically, the present invention relates to custom emojis/emoticons but not exclusively, to a method and system for dynamically generated emojis/emoticons. Due to advances in hardware and the emergence of efficient messaging technologies, conversation and communication of textual, vocal and graphical messages between parties has gained wide spread popularity. Instant messaging, short messaging service (SMS), email, chat room and other forms of textual communication protocols have become highly instrumental with use of messages containing emojis/emoticons using short messaging service and multimedia messaging service henceforth referred to as SMS and MMS respectively.

An emoji/emoticon is a meta-communicative pictorial representation of a facial expression that, in the absence of body language serves to draw a receiver's attention to the tenor or temper of a sender's non-verbal communication, changing and improving its interpretation and is used to express a person's feelings or mood through stylized pictures. An emoji/emoticon is a small digital picture or pictorial symbol that represents a thing, feeling, concept, etc., used in text messages and other electronic communications and usually part of a standardized set. Thus, the present invention can be an emoji or emoticons.

In the prior art, major players including but not limited to Apple, Google, and Microsoft have emojis/emoticons that are encoded Unicode characters that are part of their hardware keyboards. However, the purpose of this invention to provide a protocol for third party platform developers to provide a smoother user interfaces for embedding graphic images in messages of all forms (text messages, email and social media) and a way for third party developers to supply key board-like interfaces for input of these images to behave like the hardware emoji/emoticon keyboard from the major players in the mobile technology industry.

During the last decade, the diversity of existing emojis/emoticons has increased substantially, from just a few basic combinations of a “smiley face” to an overabundance of complex and rich graphical and sometimes even animated emojis/emoticons. What is needed is a system and method of communicating by embedding an emoticon that reflects the physical features of the user including skin tone. The current state of the art has failed to address the need for a broader range of emojis/emoticons that are representative of various skin tones, physical features and ethnicities. iDiversicons addresses this bias by adding to the character set of the standard emojis/emoticons. iDiversicons Version 1.0 was released in the Apple Store on Oct. 11, 2013, Version 2.0 was released in March 2014 and are compatible with iPhones, iPads and iPod Touches. iDiversicons were also launched in the Google Play Store for Android devices. iDiversicons was the first app that offered users diverse emojis/emoticons to express themselves in text and email messages. The next step is to develop font for iDiversicons to integrate into the keyboard for the Windows, Android and Mac OS X platforms. The present invention preferably includes an enhanced app to make it more user-friendly, fluid and faster to use.

### SUMMARY OF THE INVENTION

The present invention provides a method of embedding, transferring and communicating custom generated emojis/emoticons having unique physical features. One major objective of the present invention is to provide emojis/emoticons that provides with physical features of various. One of the major objectives of this invention is to provide third party developers a protocol for supplying embedded graphic images that behave like the emoji/emoticon keyboards from the major players in mobile technology industry.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a block diagram of the program flow of the keyboard IOS multi-select process.

FIG. 1a is a block diagram of the user interface flow of the keyboard IOS multi-select process.

FIG. 2 is a block diagram of the program flow of the non-keyboard IOS multi-select process.

FIG. 2A is a block diagram of the user interface flow of the non-keyboard IOS multi-select process.

FIG. 3 is a block diagram of the program flow of the keyboard IOS horizontal display process.

FIG. 3a is a block diagram of the user interface flow of the keyboard IOS horizontal display process.

FIG. 4 is a block diagram of the program flow of the keyboard Android multi-select process.

FIG. 4a is a block diagram of the user interface flow of the keyboard Android multi-select process.

FIG. 5 is a block diagram of the program flow of the keyboard Windows horizontal display process.

FIG. 5a is a block diagram of the user interface flow of the keyboard Windows horizontal display process.

FIG. 6 is a block perspective of the five skin tones offered.

FIG. 7 shows the five skin tones in emoji/emoticon form.

FIG. 8A-8L skin tone the various emoji/emoticon designs for skin tone 1.

FIG. 9A-9B the various emoji/emoticon designs for skin tone 2.

FIG. 10A-10B the various emoji/emoticon designs for biracial.

FIG. 11A-11B the various emoji/emoticon designs for skin tone 3.

FIG. 12A the various emoji/emoticon designs for skin tone 4.

FIG. 14A-14G the various emoji/emoticon designs for skin tone 5.

FIG. 15 shows a block diagram of how the diverse emoji selection process.

### DETAILED DESCRIPTION

The present invention, relates to emoticon palettes and, more specifically, but not exclusively, to a method and system for generating customized emojis/emoticons with distinctive ethnic features.

With the present invention, the software application is installed on a smart phone or other suitable mobile device and provides a graphical user interface to allow a user to select one or multiple emojis/emoticons. In one embodiment of the present invention, when installed on the mobile device a physical storage database of more than 900 emojis/emoticons are downloaded onto the mobile device.

Each emoticon emulates real unique physical features of a segment of the population. The application provides the user the ability to embed the emojis/emoticons within a message that can be broadcasted to multiple users. The emoticon database may be generated according to general textual and/or image analysis methods. Each emoticon may be associated with one or more intention indications.

The present invention includes a database of more than 900 diverse emojis/emoticons with physical features representing the actual diverse population within the world. To represent the entire diverse population emojis/emoticons having physical features from the group consisting of African-American and Asian to Latino/Hispanic, Indian, Caucasian and Biracial were chosen. The physical features include hair texture, hair color, facial structure, eye color, eye structure, as well as other features. Skin tone is distinctive physical feature that can be varied within a specific ethnic population. The database also includes a plurality of emotional expressions, so that each emoji/emoticon can present a unique avatar for the user. With a variety of hobbies, religious beliefs and professions, the present invention creates an emoji/emoticon that is an improvement over the simple emoji/emoticon smiley icons. The mobile application is compatible with iPhone, iPad, iPod touch, requiring iOS 6.0 or later. The mobile application can also support android devices and tablets and the Windows 10 and 8.1 mobile and desktop platforms. The application can be used with Text Messages, Email, Facebook, Twitter, Instagram or other compatible messaging systems.

The mobile application, iDiversicons, has a graphical user interface that is user-friendly, fluid and faster to use. In addition, the present invention includes capabilities of importing to social media. A user can select a single emoticon or use the multi-select feature to select multiple emojis/emoticons from the database. In an alternative embodiment, the plurality of emojis/emoticons can be implemented within a software keyboard application which provides a more seamless user interface. In one embodiment, the graphic user interface can be an emulated software keyboard that displays segments of the 900 diverse emojis/emoticons. In another embodiment, emojis/emoticons are selected from a display and physically pasted into the text message. Below are multiple examples of various embodiments that illustrate the steps of operation of several of the iDiversicons software mobile applications.

### MULTI-SELECT METHOD for SIMULATED iOS SOFTWARE KEYBOARD

1. Open the iDiversicons keyboard in text messaging or email

2. Double tap the keyboard to Activate multi-select

3. Select/Copy by tapping (copies) on multiple emoji/emoticon from 1 or all 5 categories

4. Place your finger over the text message box or in the body of the email where

the user wants to paste the emoji/emoticon.

5. Type your message or the user may send without text

7. Add the name or email address for the recipient

6. Press the send button for text message or email

### Multi Select for iOS Non Keyboard

1. Long press iDiversicons and select up to 5 at a time

2. Click the share link in the top right corner

3. Import into text message, email or social media

4. Type message and send or post into social media

### Multi Select for Android Application

From iDiversicons app select any images you like and “save to SD”

1. Go to text message

2. Select contact you want to send message to

3. Add text

4. Select paperclip in top right corner

5. Select slideshow

6. Hit the plus in the bottom left corner

7. Select “existing picture”

8. Select “SD card”

9. Select image of choice -repeat steps 6-9 until desired selections are complete

10. Hit done in top right corner

11. Press send

### Multiselect for Horizontal Display for Windows

1. Open Windows iDiversicons Mobile App

2. User double taps screen to activate and select multiple emojis/emoticons to copy from datastores

3. The emojis/emoticons election are collected

4. The collected emojis/emoticons are outputted to multiple emoji/emoticon horizontal display.

5. User double taps screen to de-activate multiple horizontal display.

6. User selects messaging to attach selected emojis/emoticons.

7. Message is sent.

### Multiselect For Horizontal Display for IOS Keyboard

1. Open the iDiversicons keyboard in text messaging or email.

2. Double tap the screen and select up to 5 emojis/emoticons

3. Emoji/emoticon selection is stored on clipboard

4. Emoji/emoticon sentence is displayed

5. Hold finger over text message or email to paste and send

6. Double tap screen to deactivate multi select

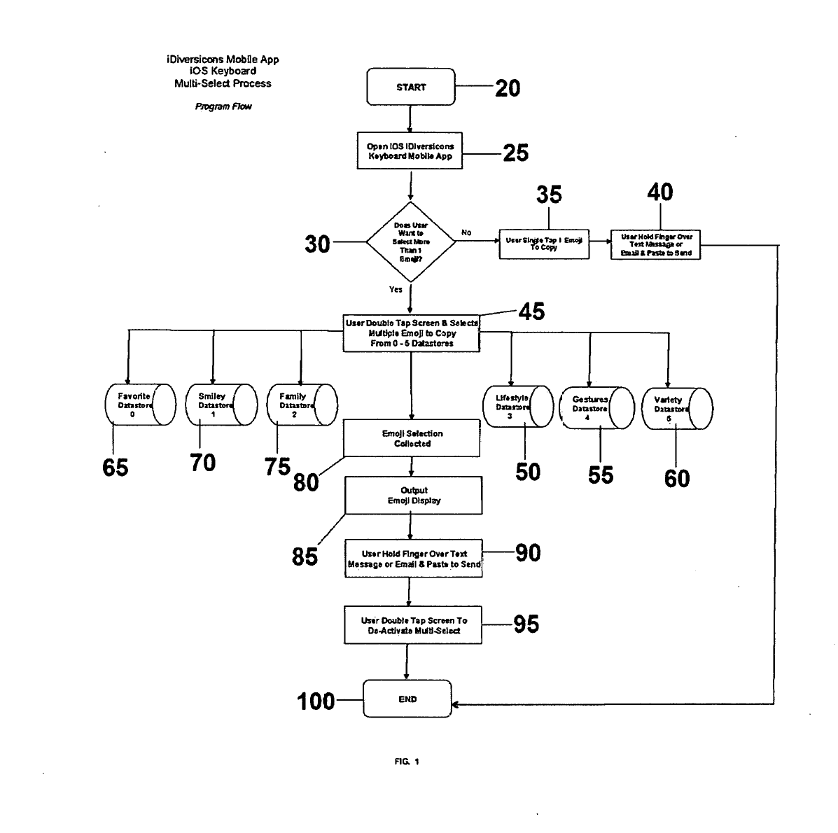

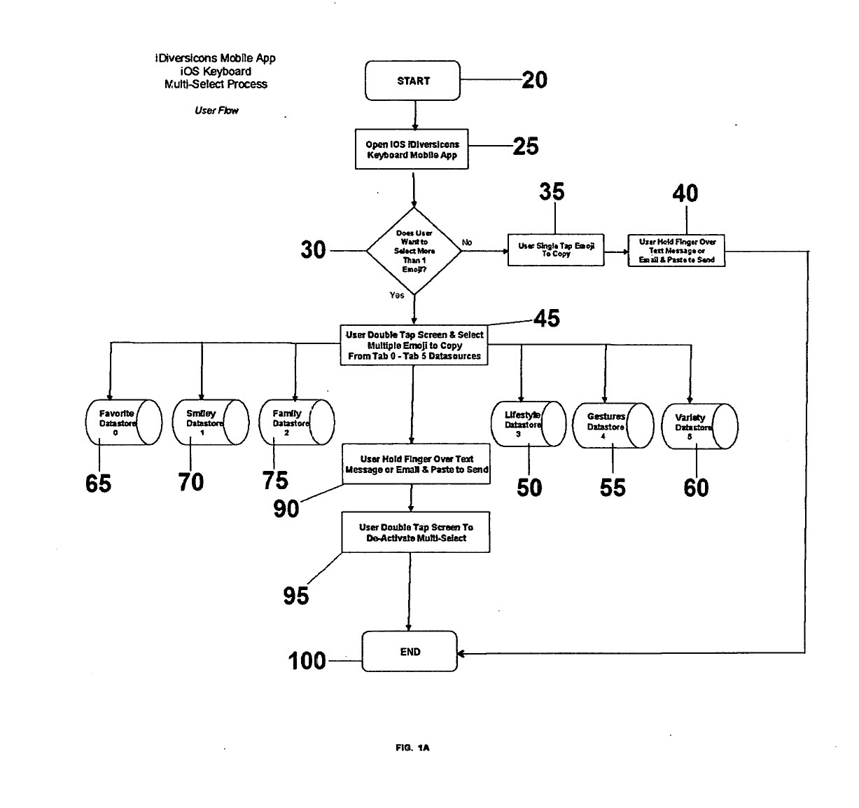

Referring to FIG. 1-5a there is shown the following data stores wherein at least 900 pre-defined images are physically stored.
Smiley Data Store (70)
Family Data Store (75)
Life Style Data Store (50)
Gestures Data Store (55)
Variety Data Store (60)
Favorite Data Store (65)

Each physical data storage medium listed above can be further grouped by the following ethnic groups:
African-American, African;
Asian;
Latino/Hispanic;
Indian;
Caucasian; and
Biracial.

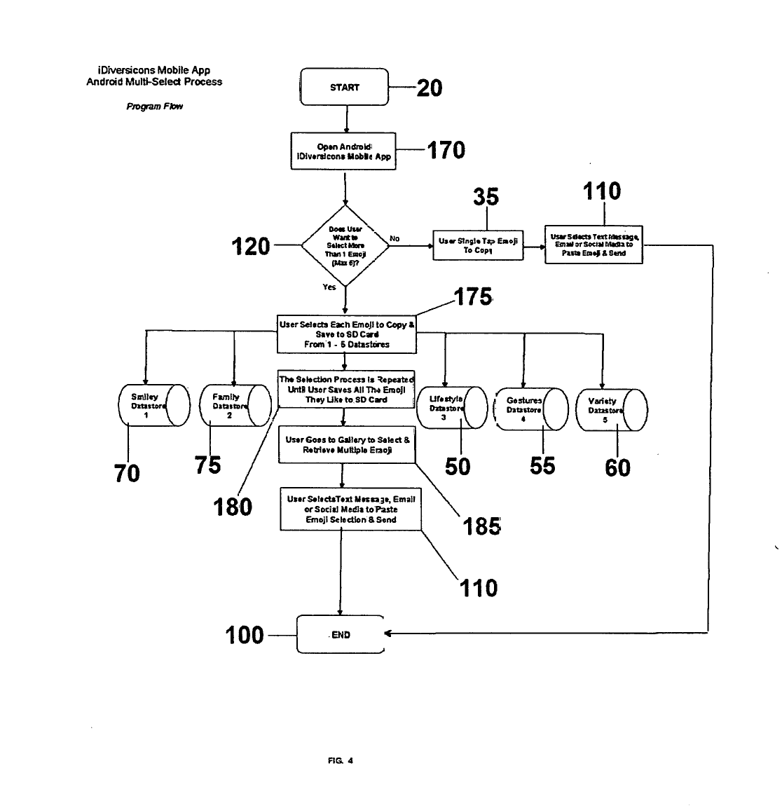

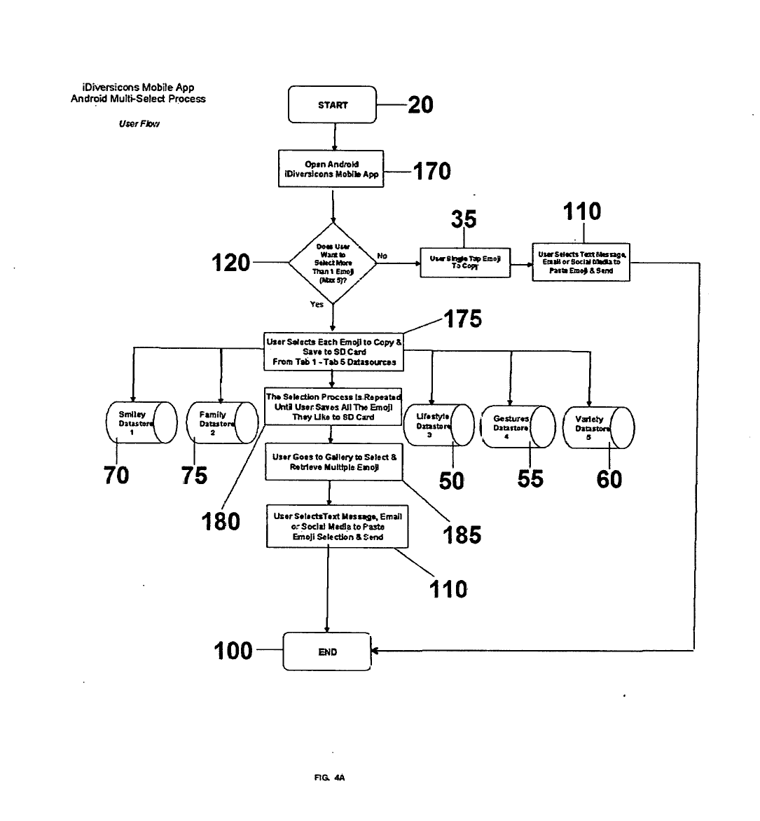

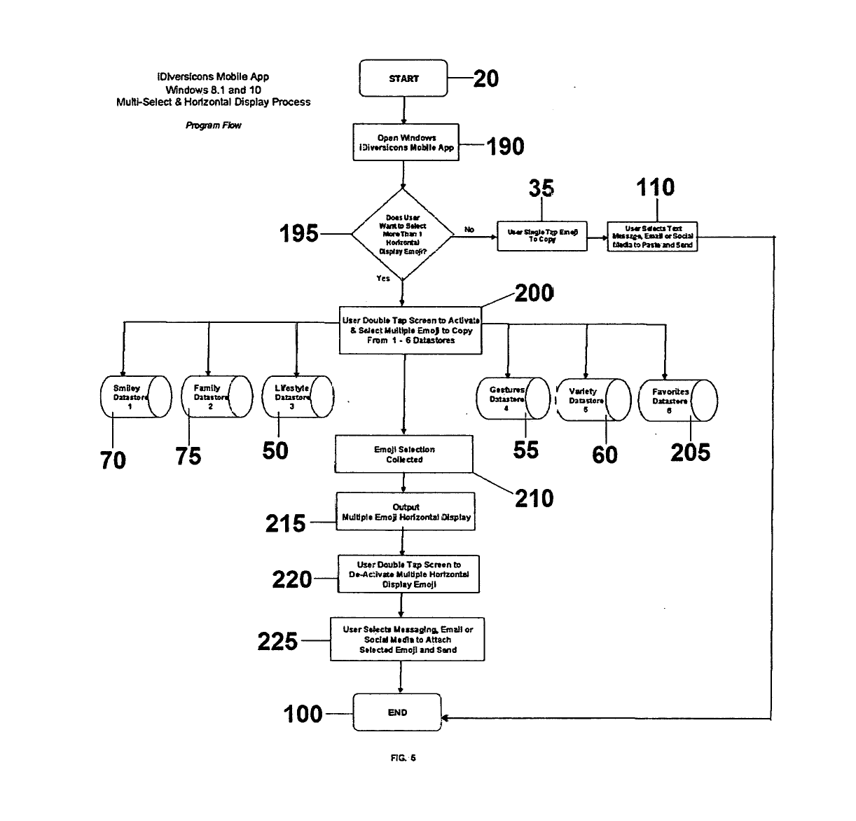

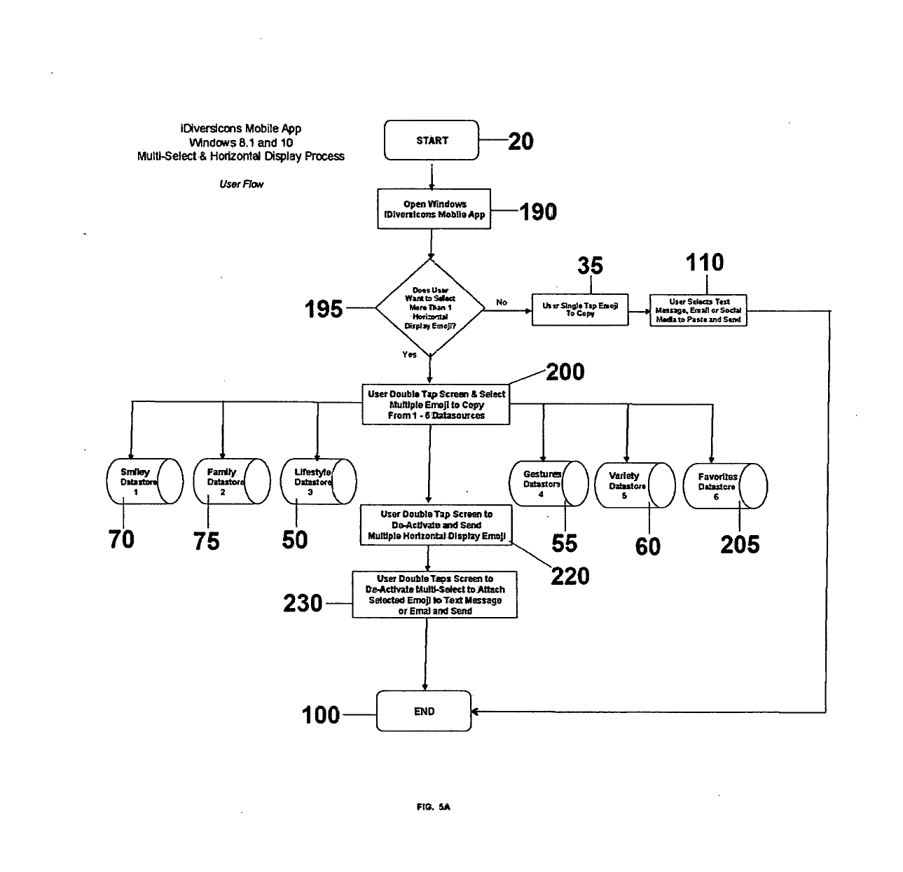

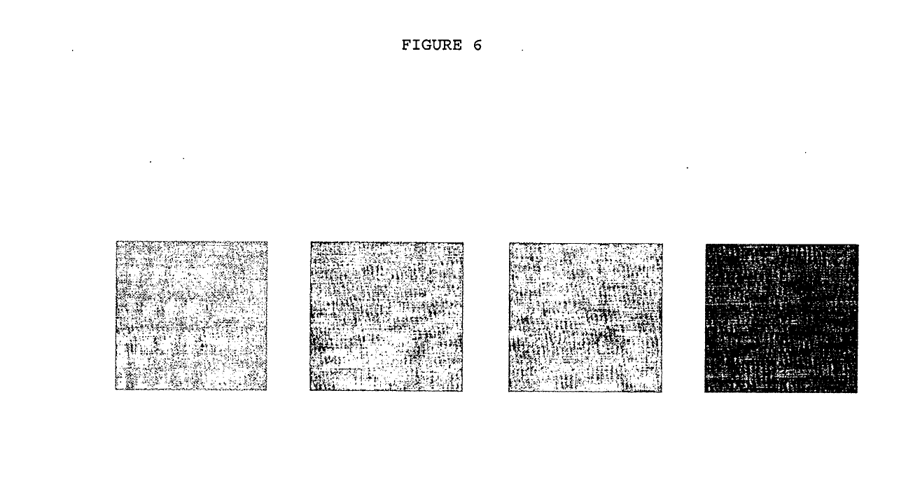

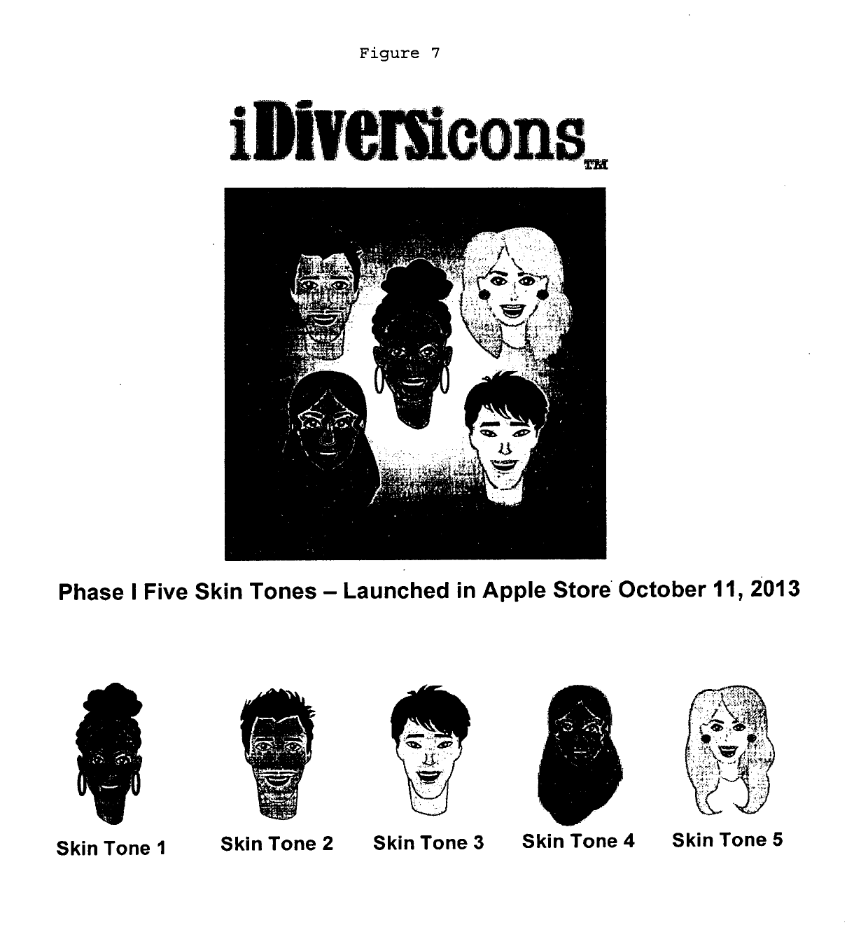

Each ethnic group can be further subdivided into the following five skin tones illustrated in FIG. 6:
Ivory/Light tone;
Toffee/medium tone;
Fair tone/olive;
Deep tone/chocolate; and
Deep tone/bronze.

Generally, the mobile applications for Apple, Android and Windows have their graphical emojis/emoticons implemented on a hardware keyboard interface. The present invention has developed a software user interface that emulates the hardware keyboard interface for Apple, Android and Windows mobile device. The software keyboard interface presents the user with a seamless user interface between the iDiversicons application and the mobile device hardware interface. Alternatively, the user interface is a display of diverse emojis/emoticons for selection by the user on the mobile device.

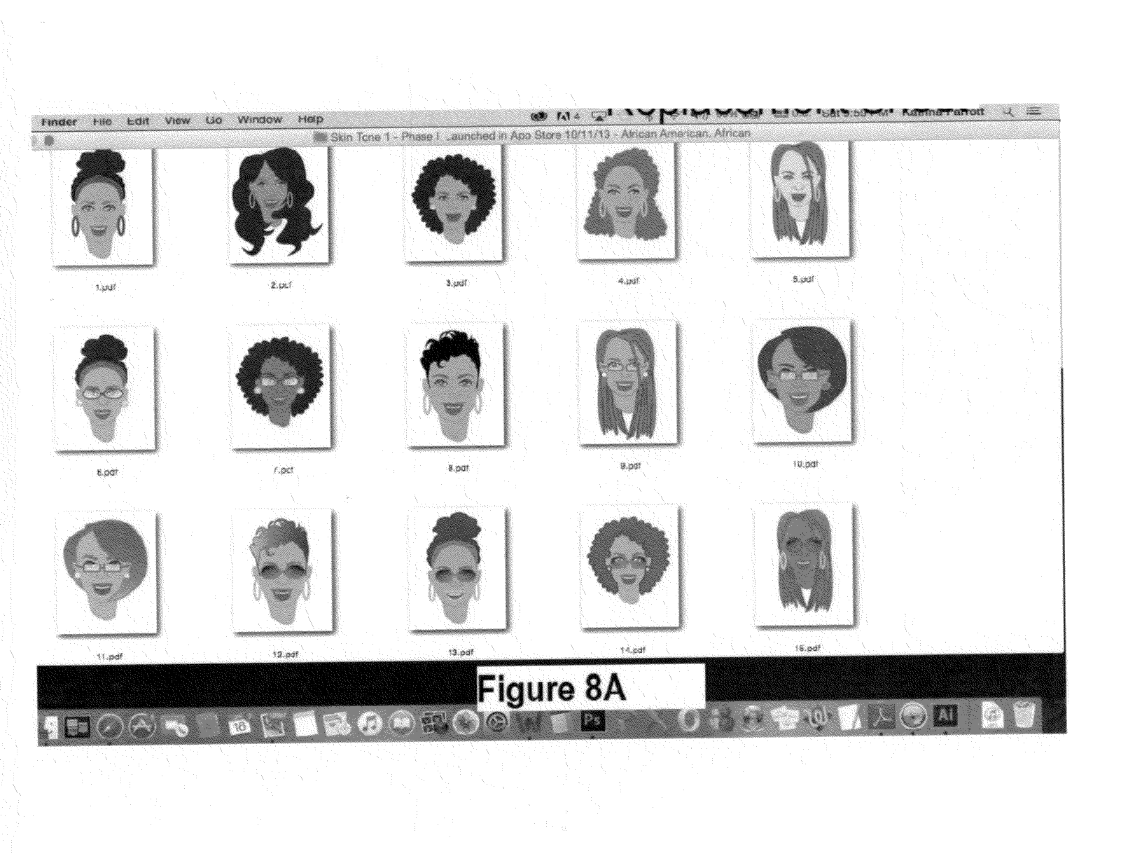

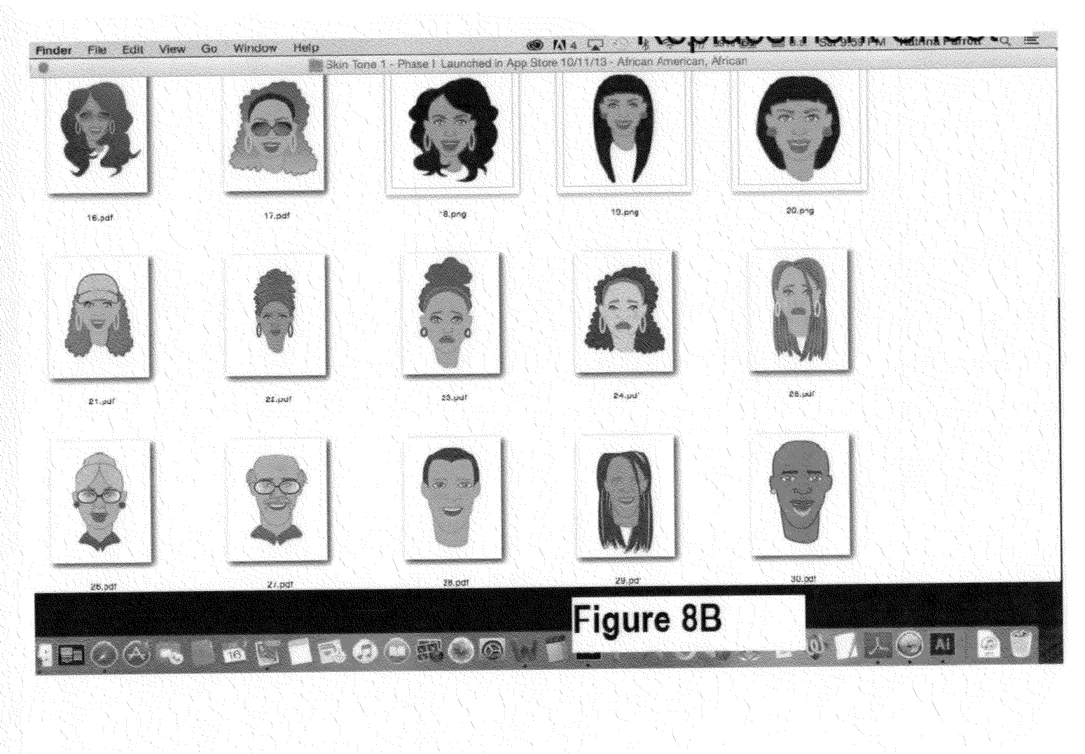

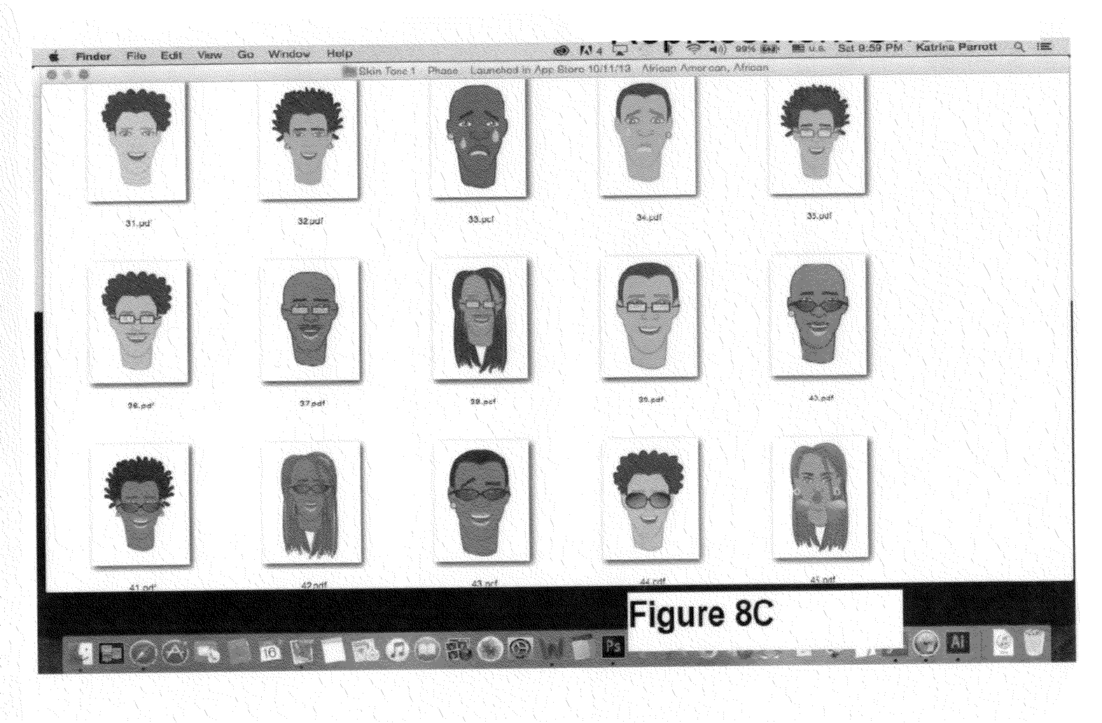

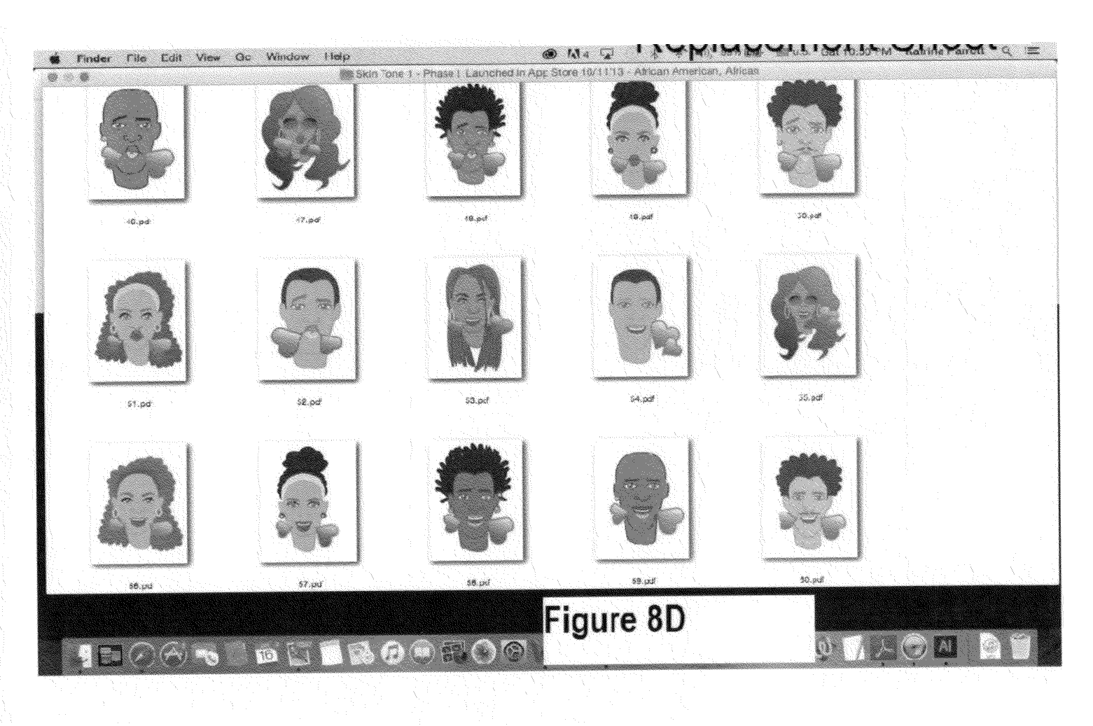

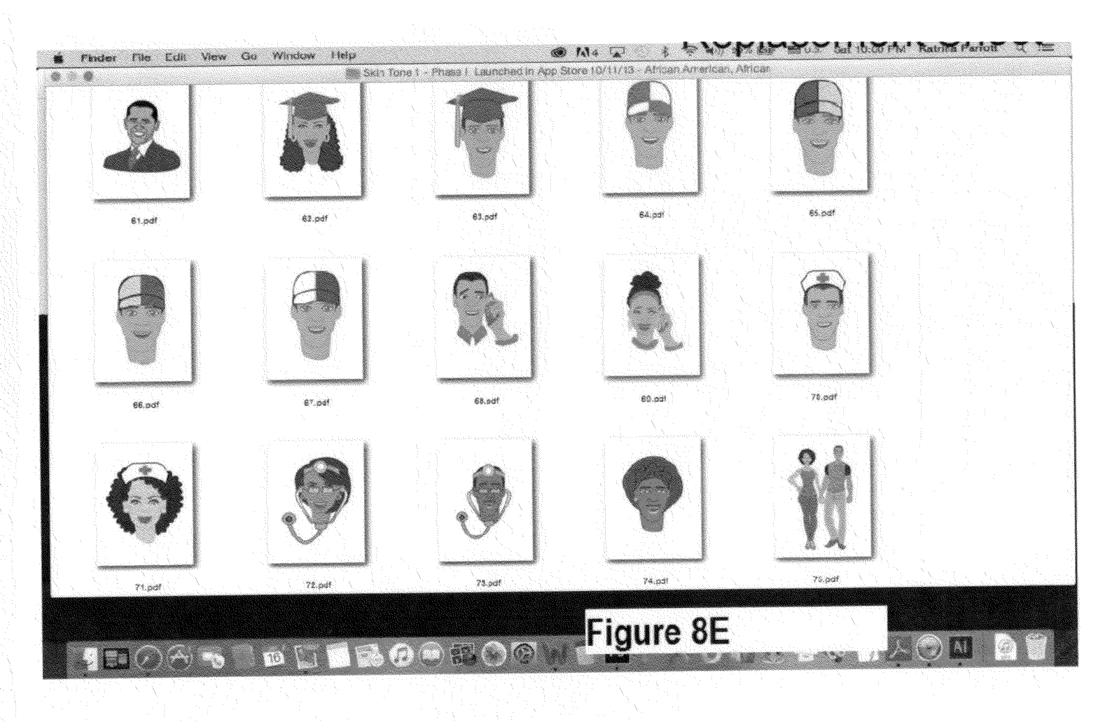

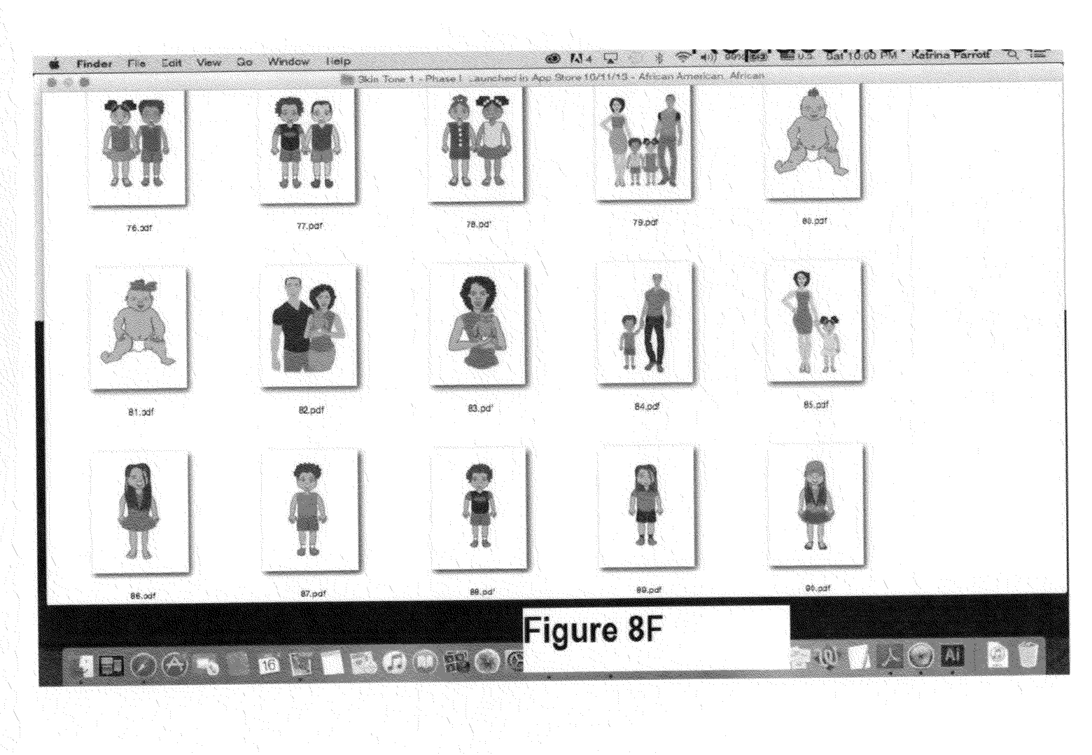

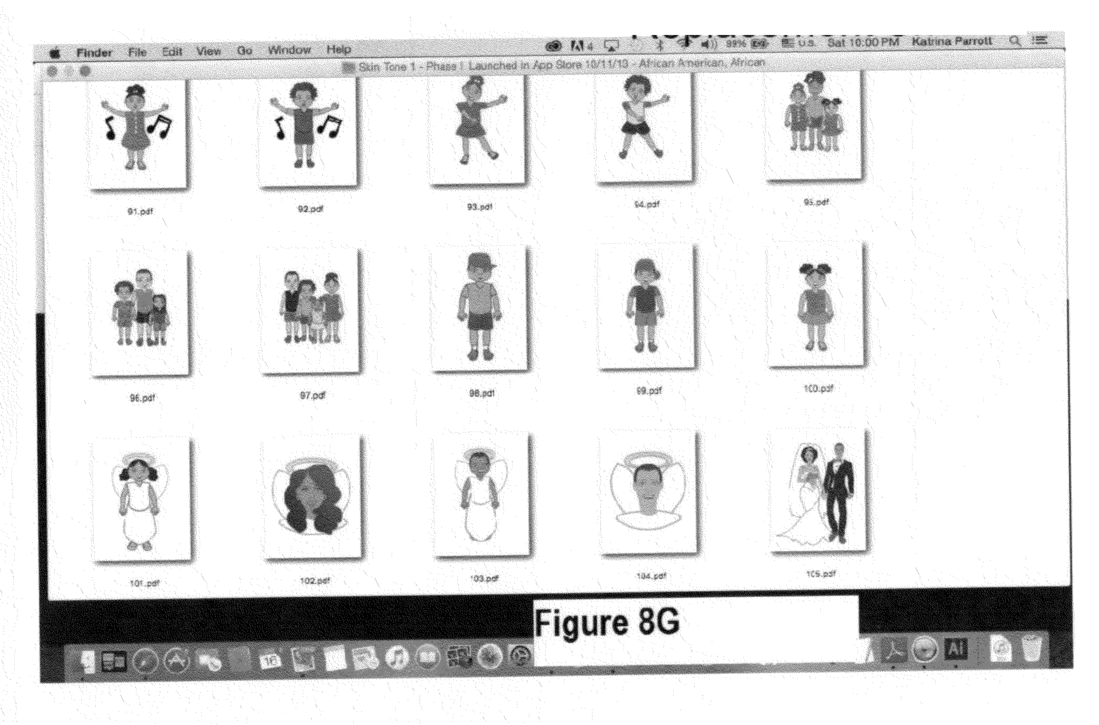

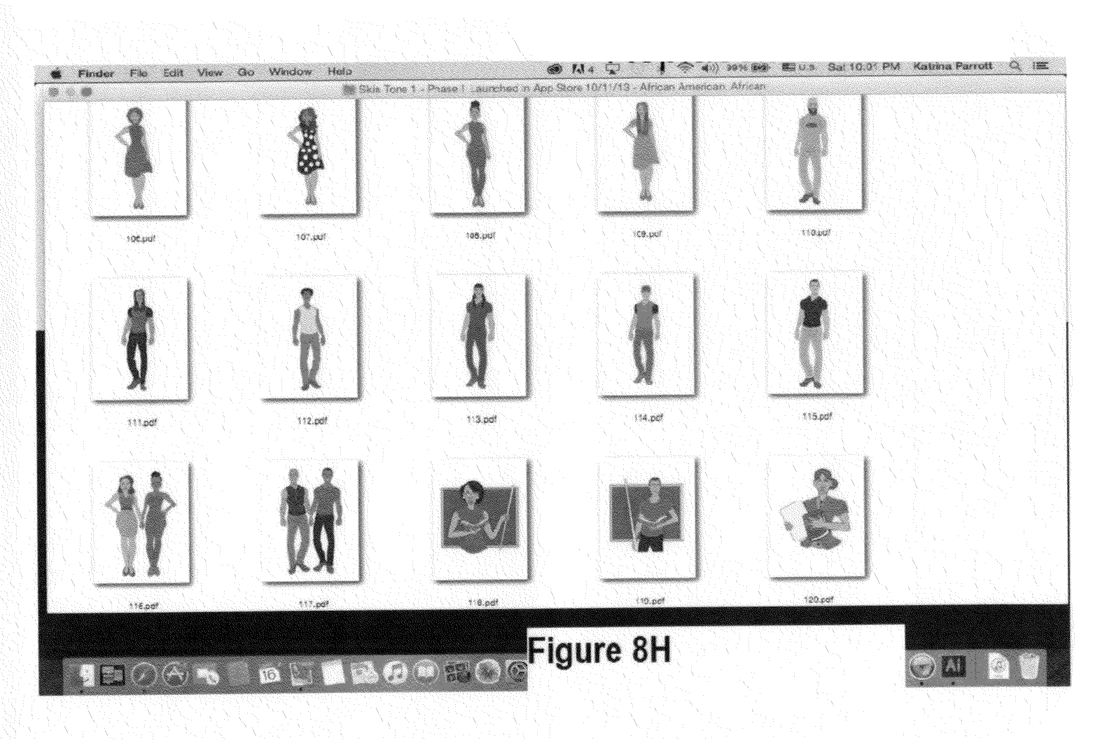

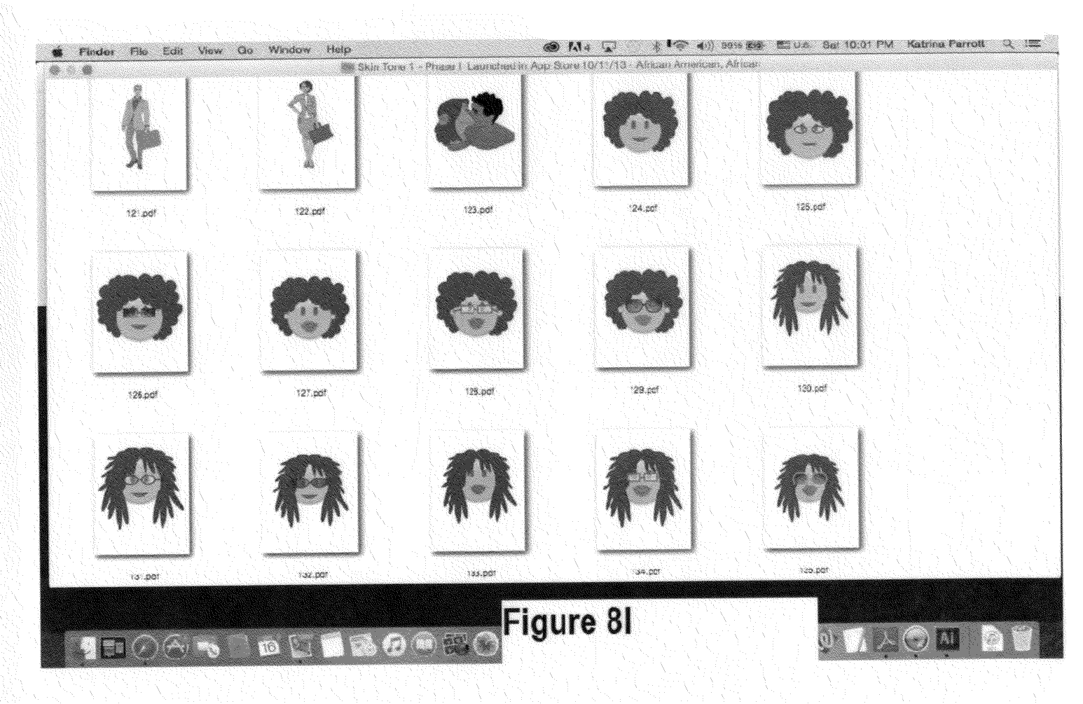

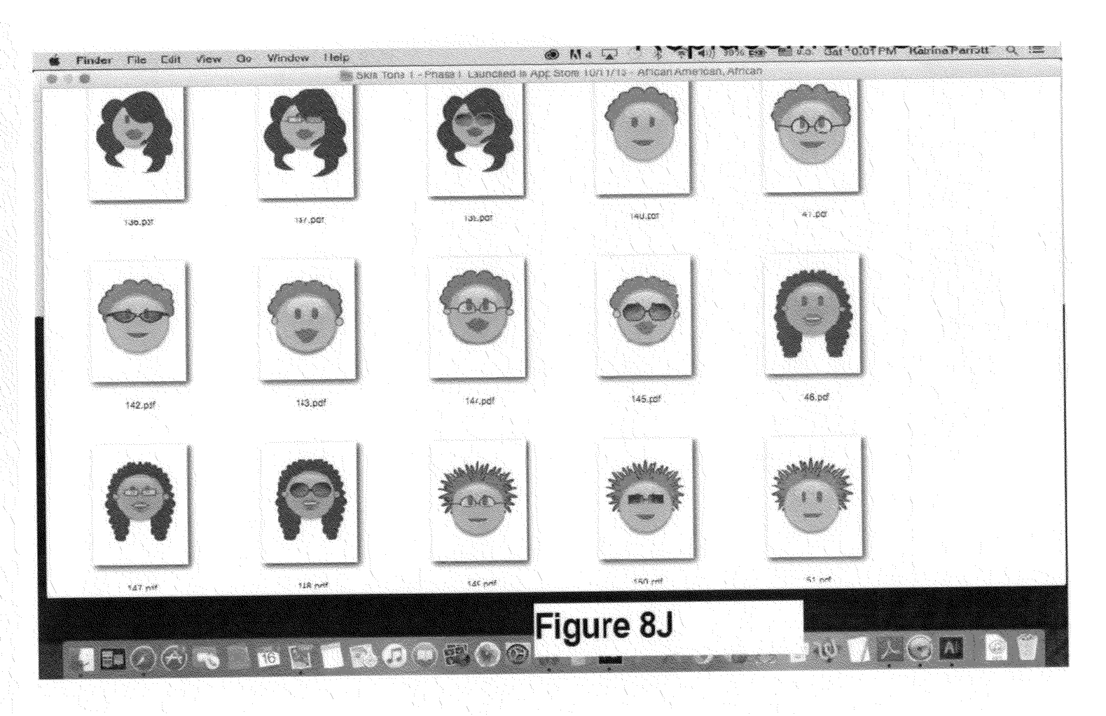

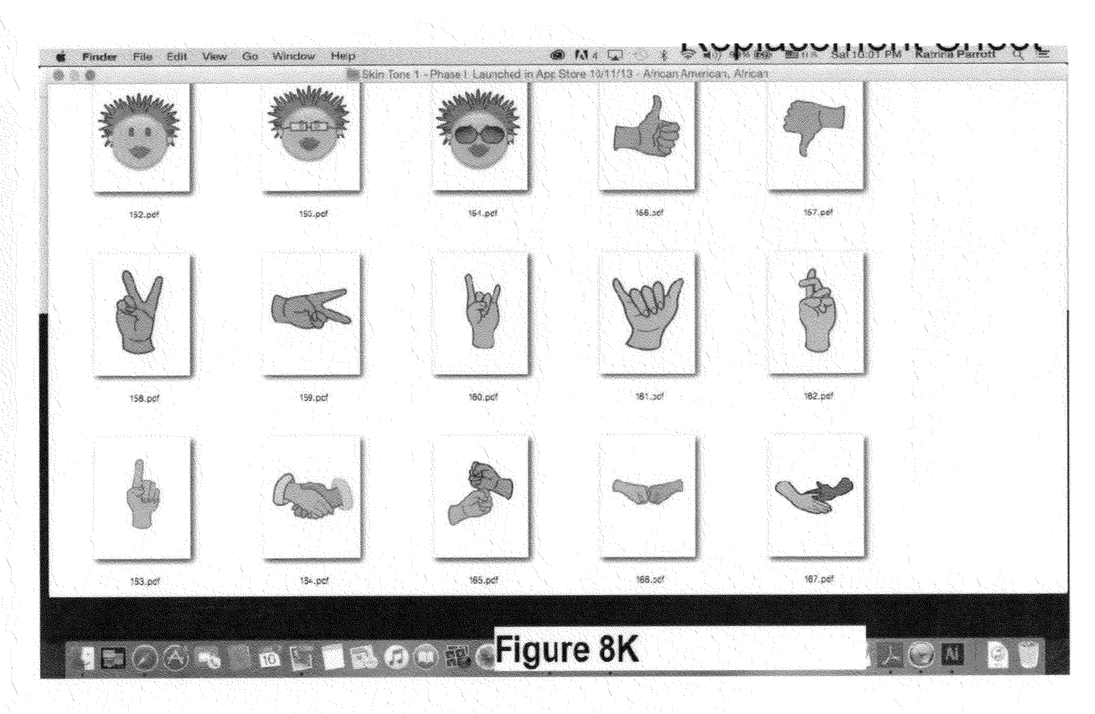

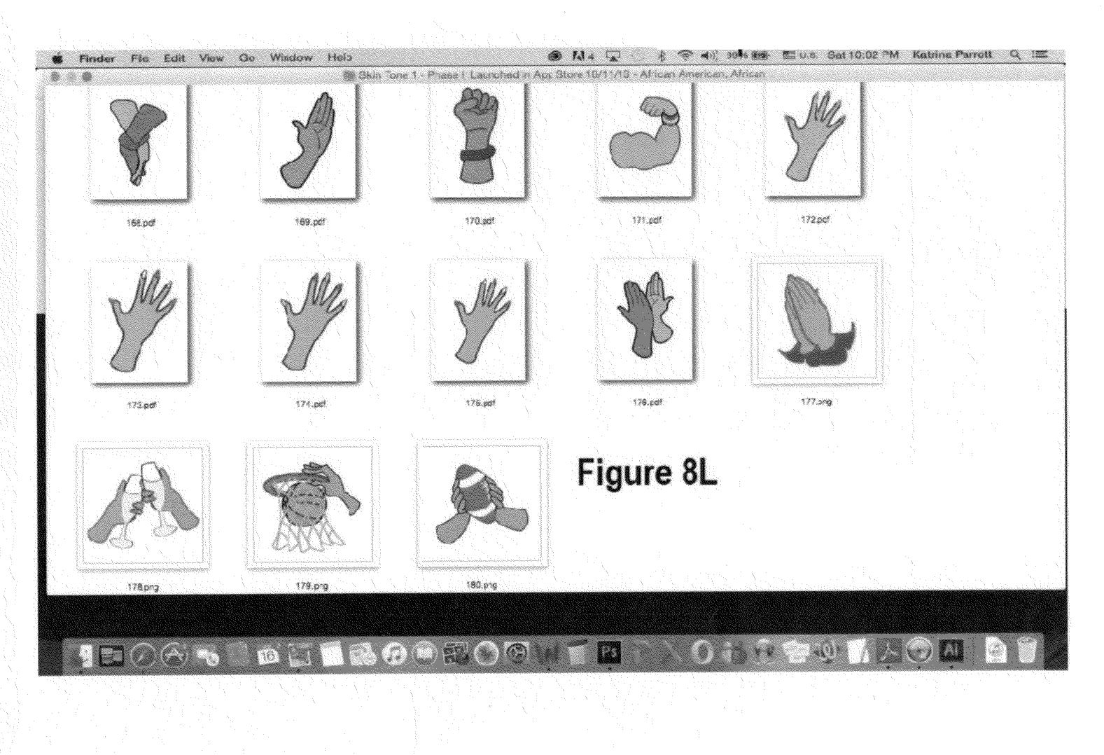

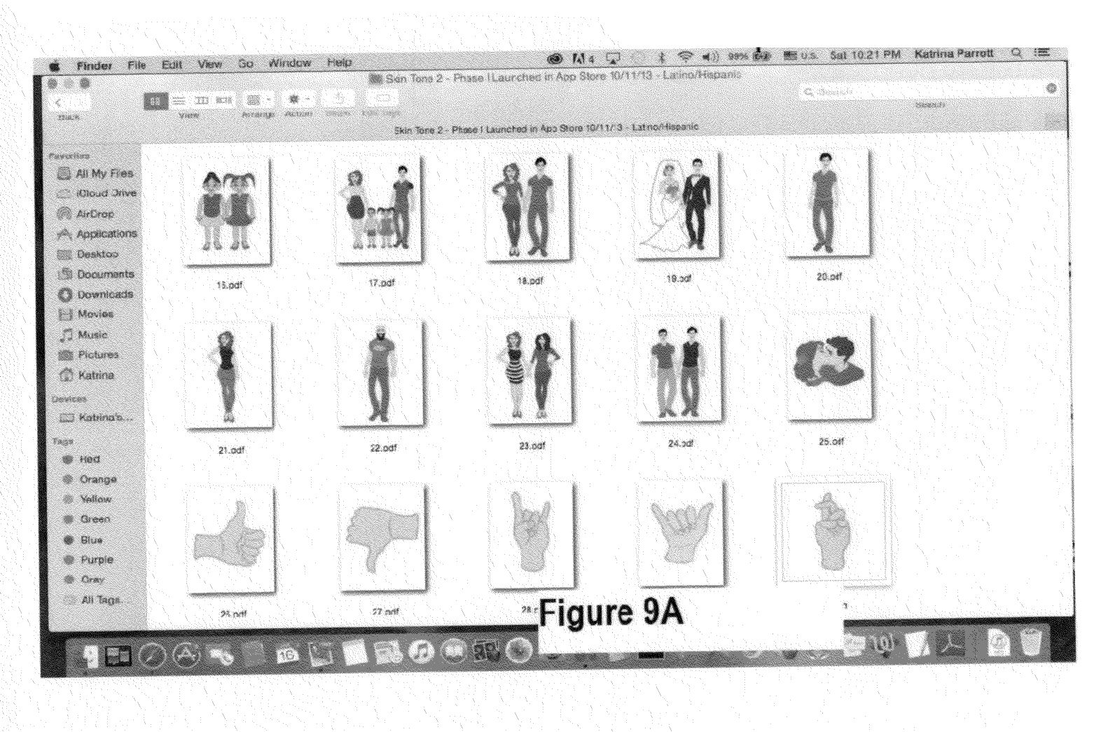

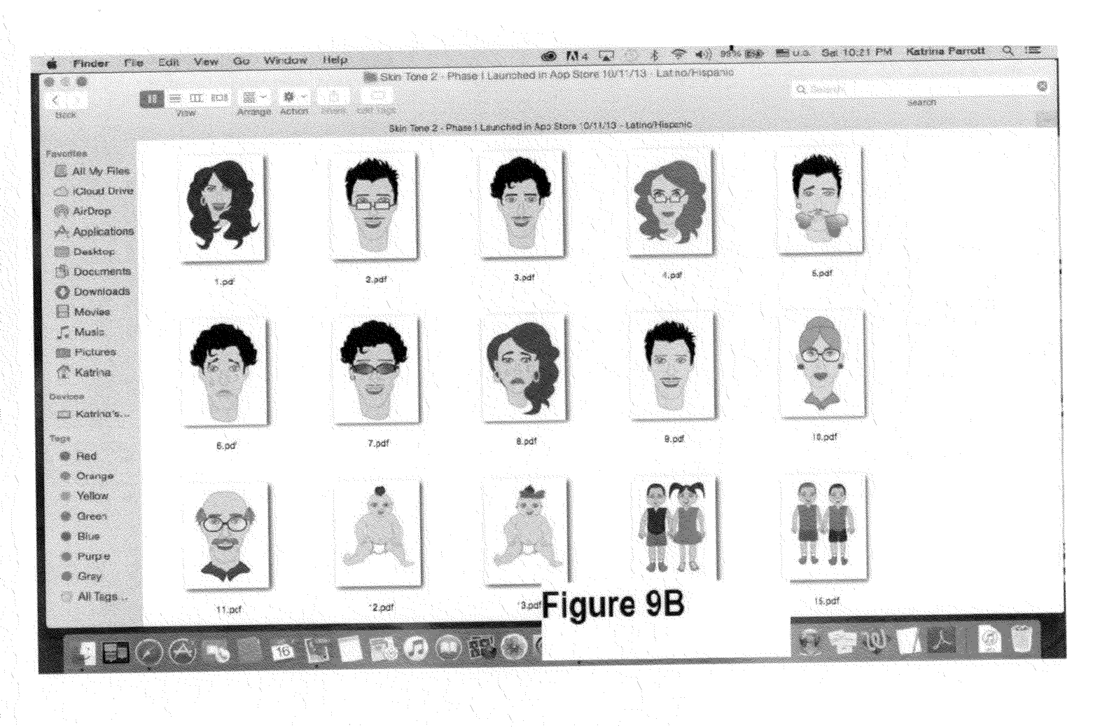

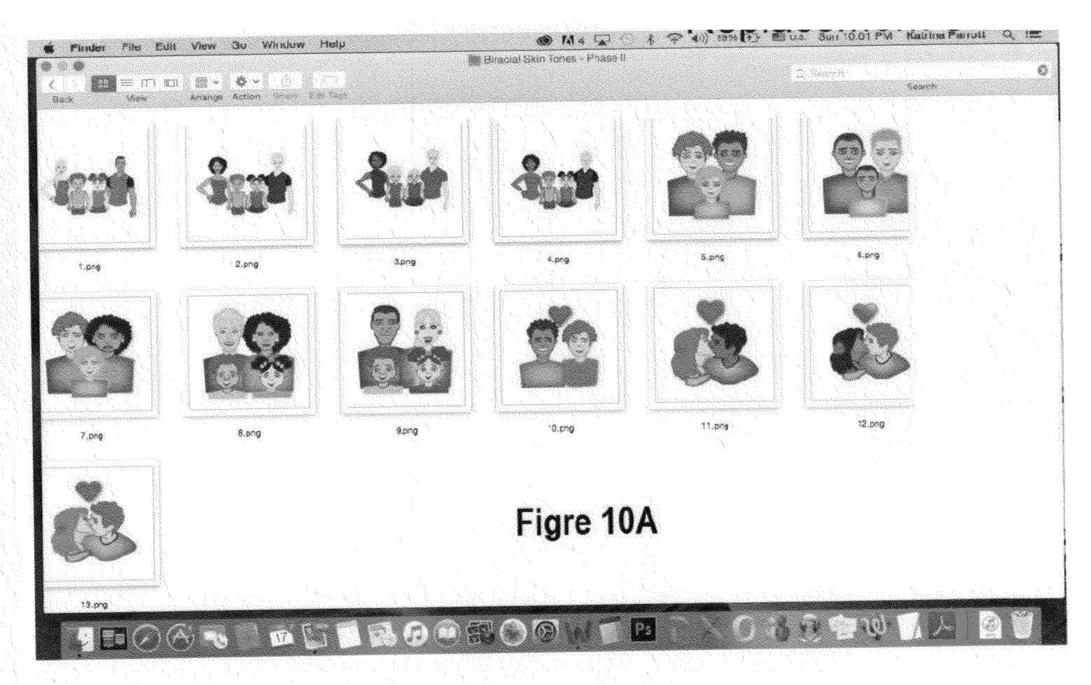

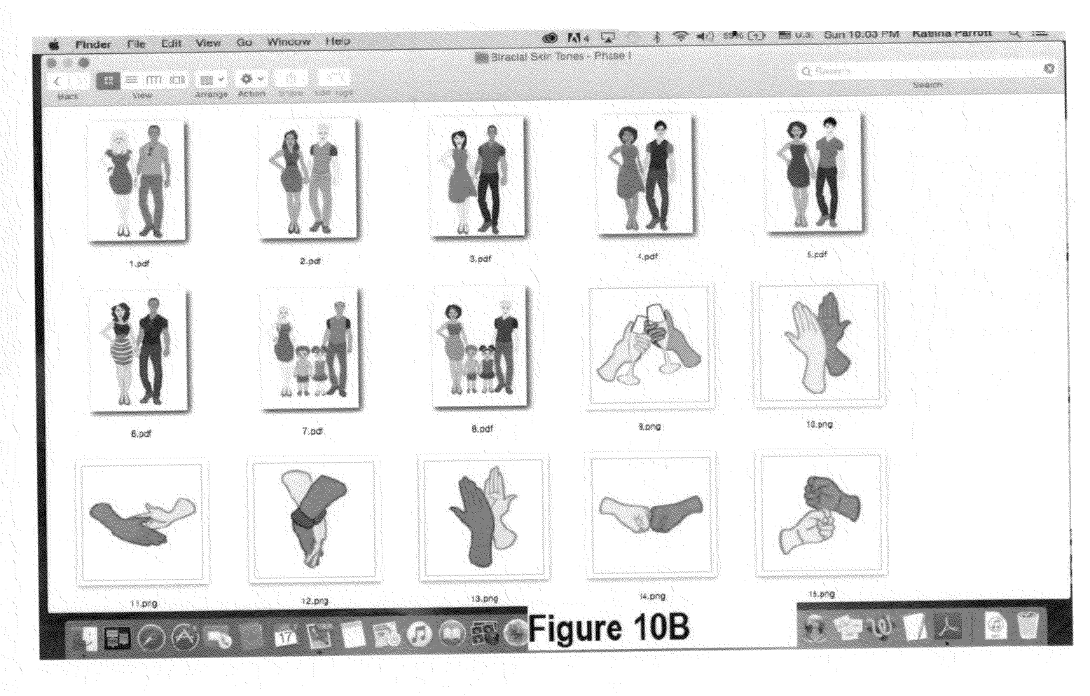

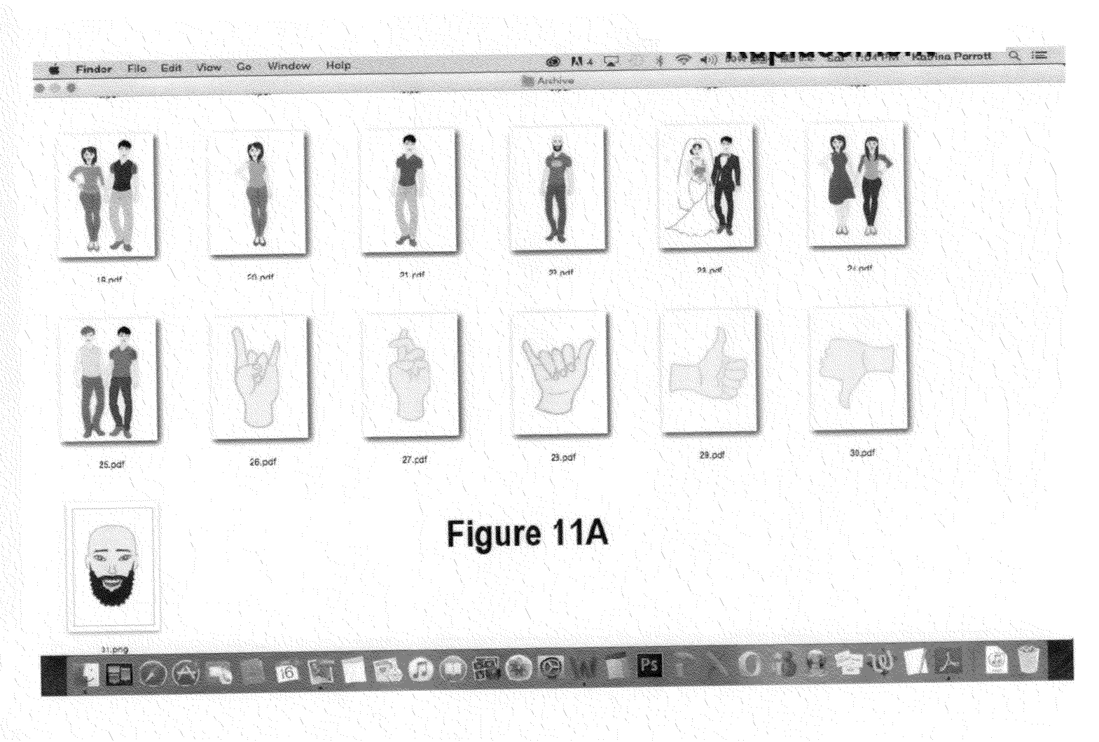

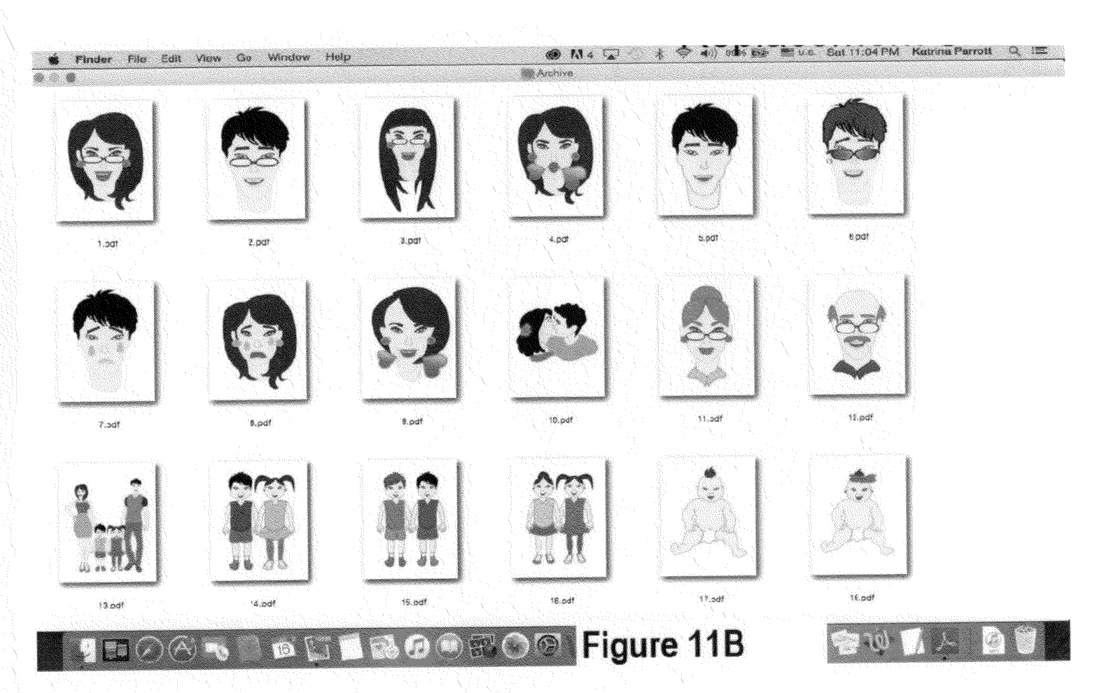

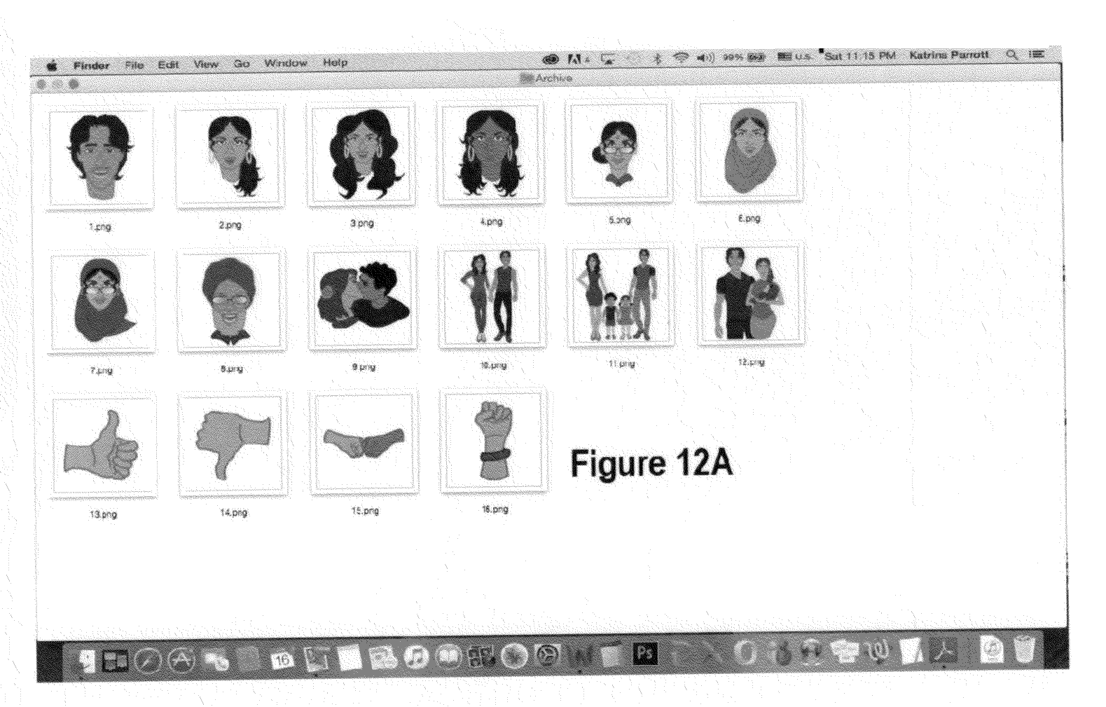

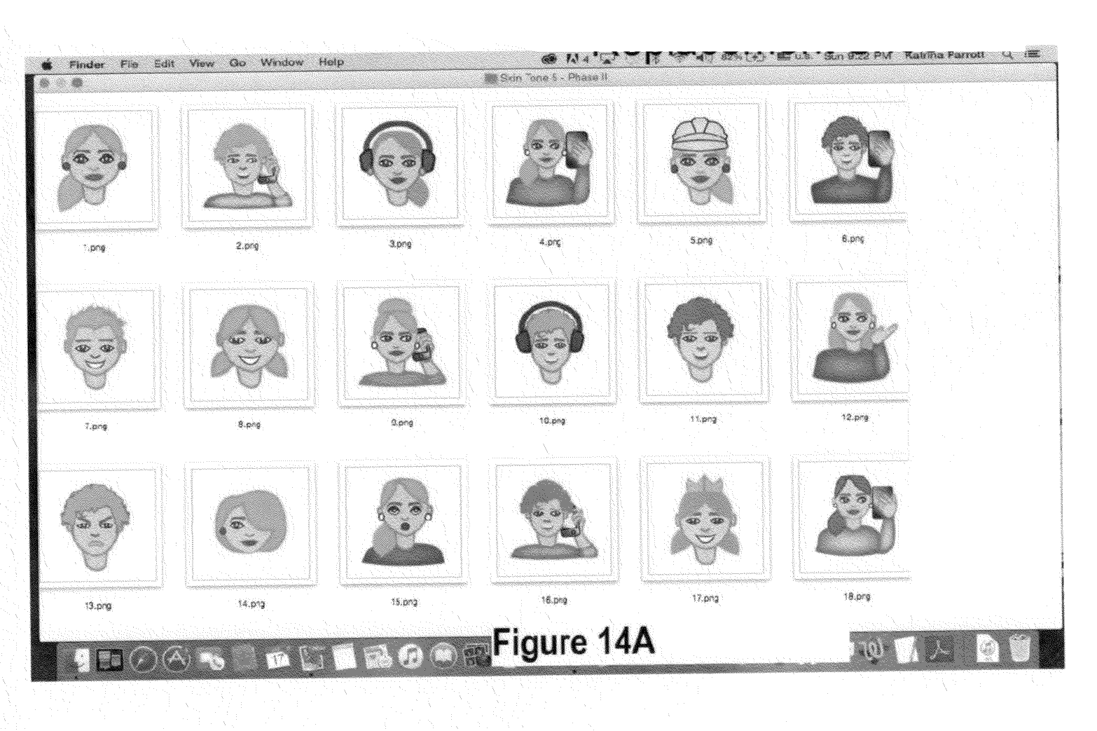

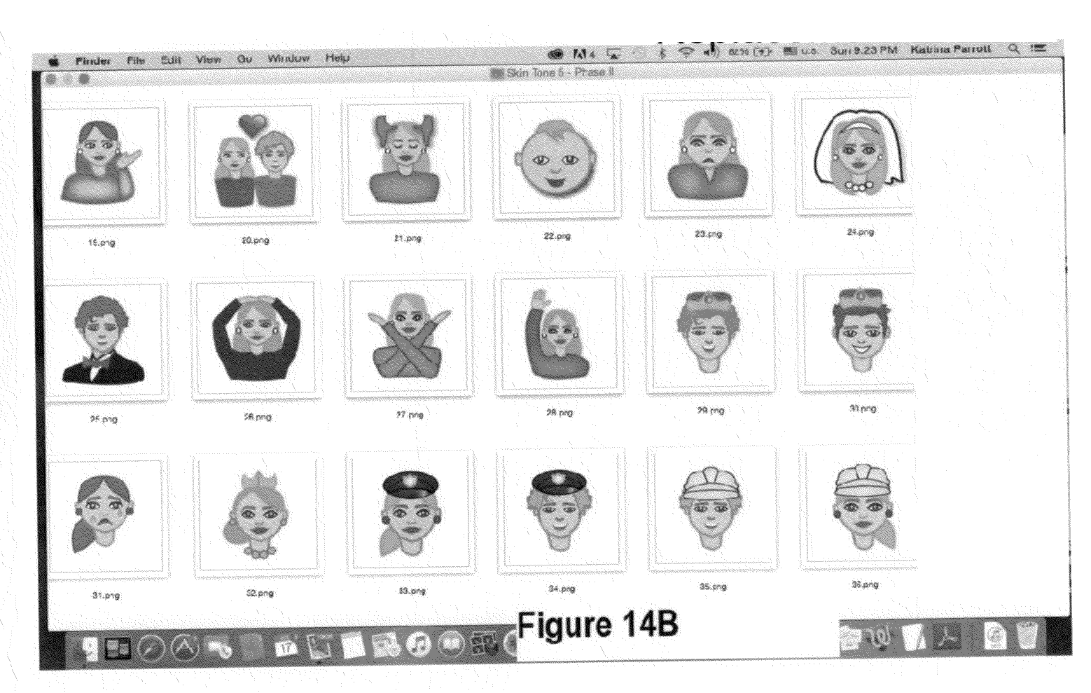

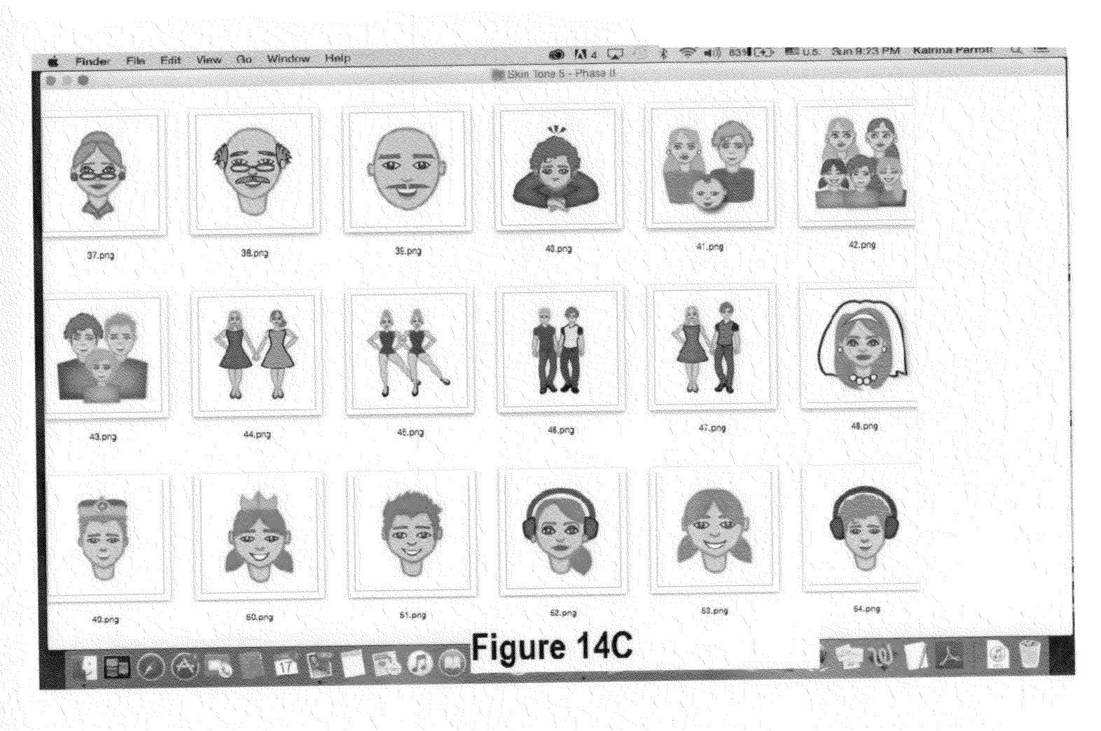

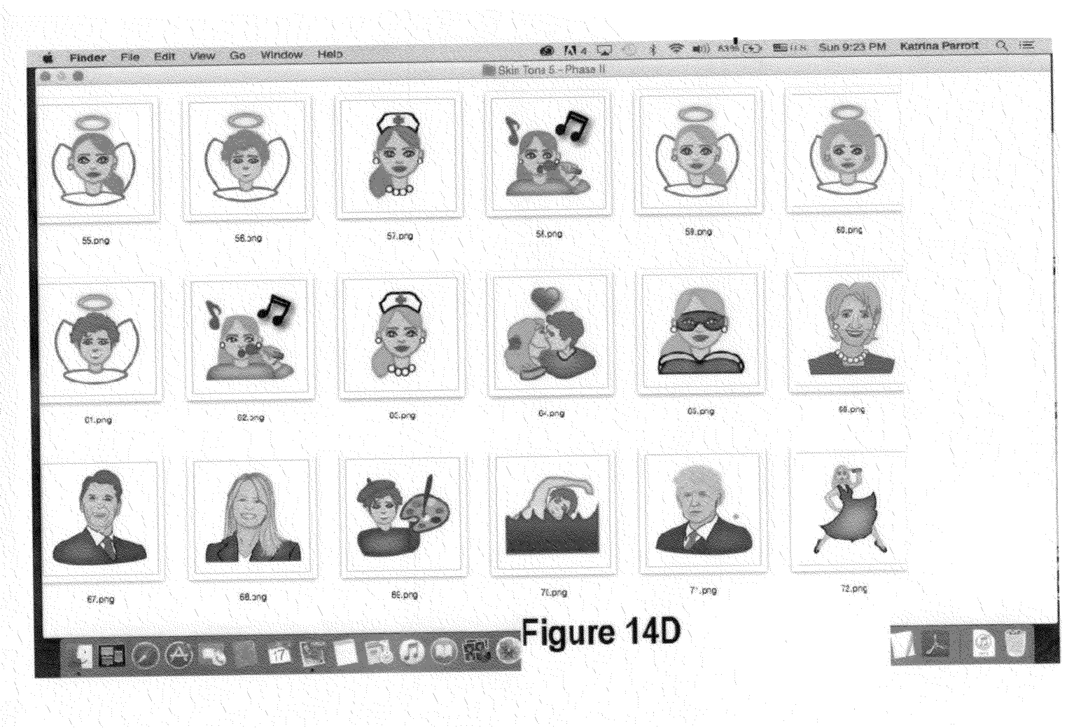

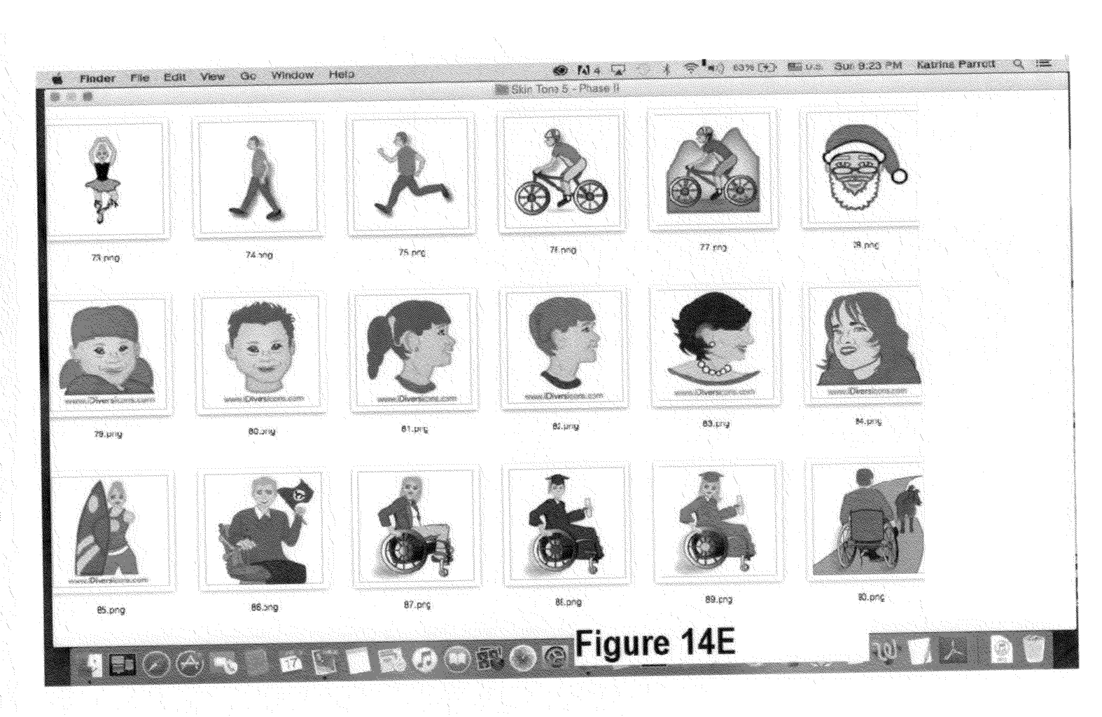

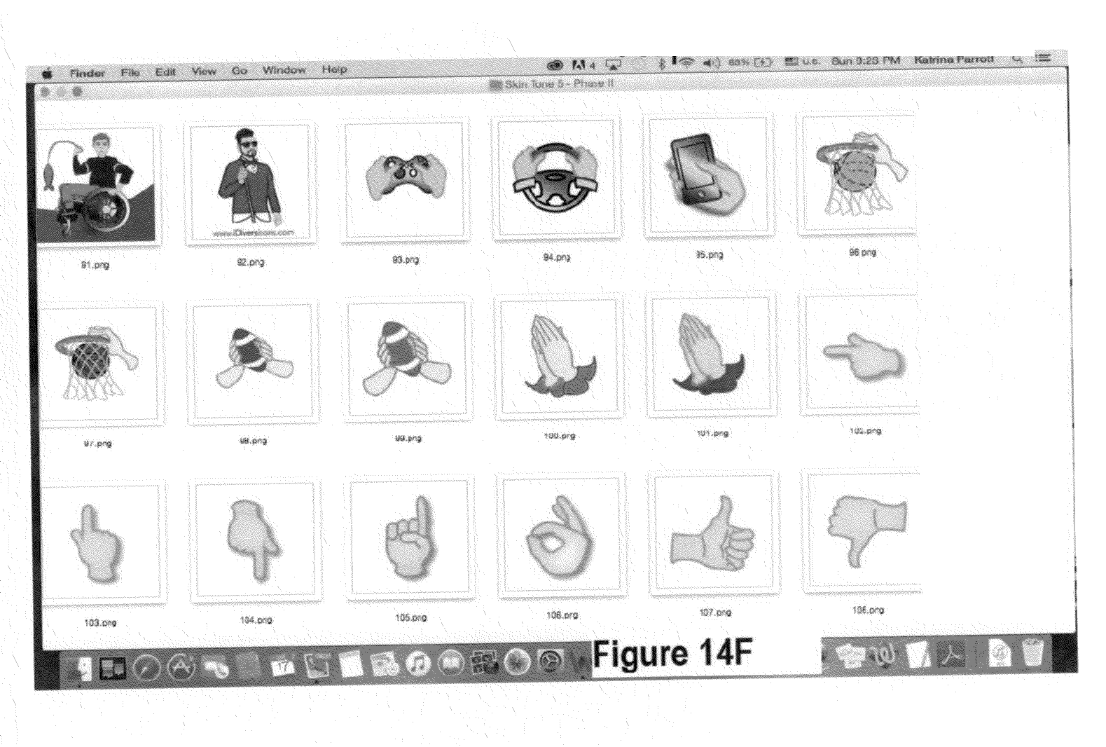

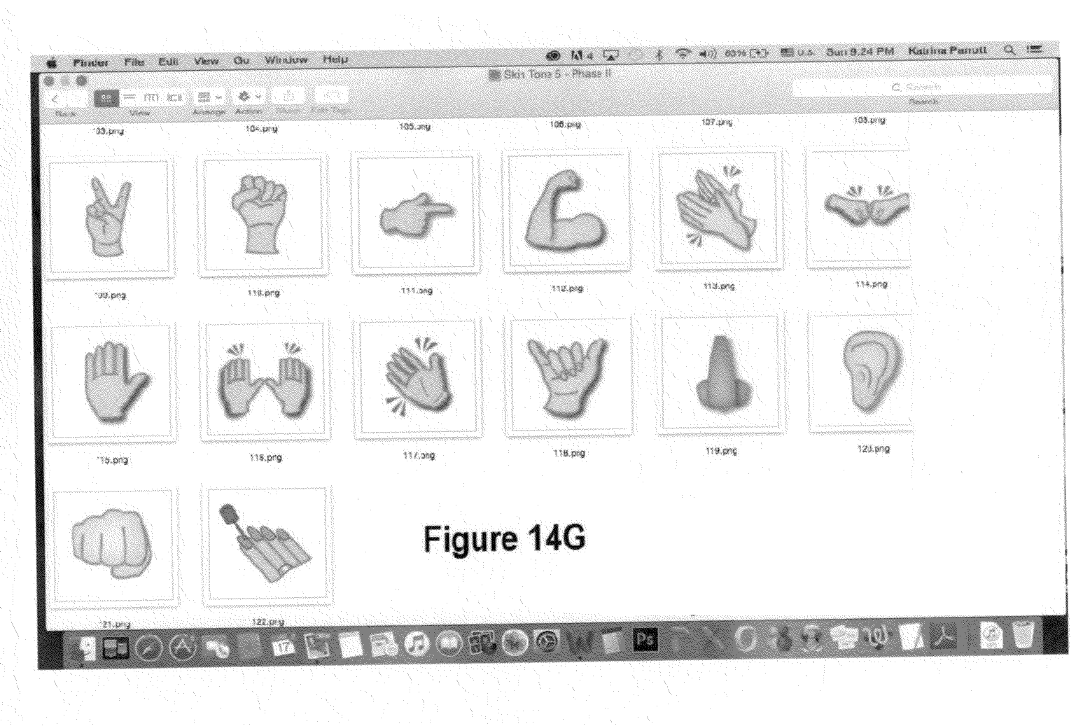

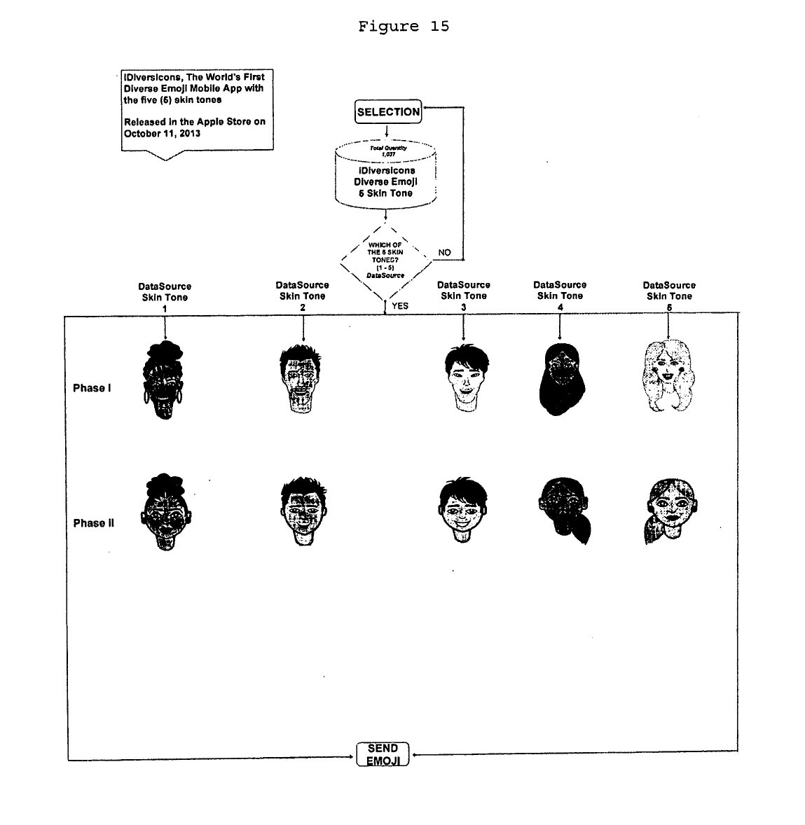

The system implements a novel multi-selection mode for the selection of diverse emojis/emoticons on Apple, Android and Windows. From the user interface the user is provided the capability of selecting an emoji/emoticon from a specific group of ethnic background with specific physical features and then the user is also provided the capability of selecting a specific skin tone from the provided five-skin tones as shown in FIG. 6. FIGS. 8A to 8L illustrates to skin tone 1; FIGS. 9A to 9B illustrates to skin tone 2; FIGS. 11A to 11B illustrates to skin tone 3; FIGS. 12A illustrates to skin tone 4; and FIGS. 14A to 14G illustrates to skin tone 5; and FIGS. 10A to 10B illustrates biracial. The user is allowed the capability of selecting a plurality of diverse emojis/emoticons with a specific skin tone selection. In the embodiment of the present invention the system allows up to five diverse emojis/emoticons to be selected for transmission as illustrated in FIG. 15.

The system implements a novel feature of displaying diverse emojis/emoticons in a horizontal container on the display of the mobile device. Generally, the emojis/emoticons are displayed vertically as they are selected by the user on the mobile device display. However, the system has developed a unique method of horizontally displaying diverse emojis/emoticons. In the present invention, the user selects a plurality of diverse emojis/emoticons that are initially displayed vertically. Based upon the total aspect ratio of the group of vertically displayed emojis/emoticons, a physical horizontal container on the mobile device display is created wherein the group of diverse emojis/emoticons are displayed therein.

Referring to FIGS. 1 and 1a, there is shown the multi-select process and user interface flow. At step 25, the user opens the user interface of the mobile application stored on the mobile device and a simulated keyboard user interface is displayed. At step 30, the user determines whether to select multiple emojis/emoticons. At step 45, the user selects multiple emojis/emoticons utilizing a software keyboard interface wherein the emojis/emoticons are displayed thereon. The user interface displays to the user the family category. Once the user selects a family category, the user is provided the option of selecting the ethnic and then a skin tone within that ethnic background as noted above. The system shows a display with an actuator button which allows the user to select the ethnic predefined emoji/emoticon and a second actuator button to select the predefined skin tones. At step 80, the collected diverse emojis/emoticons of a particular skin tone is stored temporarily in a buffer. Utilizing the user interface the user, the collected emojis/emoticons are outputted to the display at step 85. To activate the multi-select feature, a user double taps on a selected emoji/emoticon. Each selected emoji/emoticon is stored temporarily in a buffer until the user completes its selection. Then the user pastes the selected emoji/emoticon(s) into the message editor. The user can repetitively select as many emojis/emoticons into the message editor as desired. At step 90, when the user has completed selecting the emojis/emoticons, the collected emojis/emoticons are submitted by text messaging or email communications services implemented on the smart phone. At step 35, if the user only wants to send one emoji/emoticon, the emoji/emoticon is collected and then transmitted at step 40.

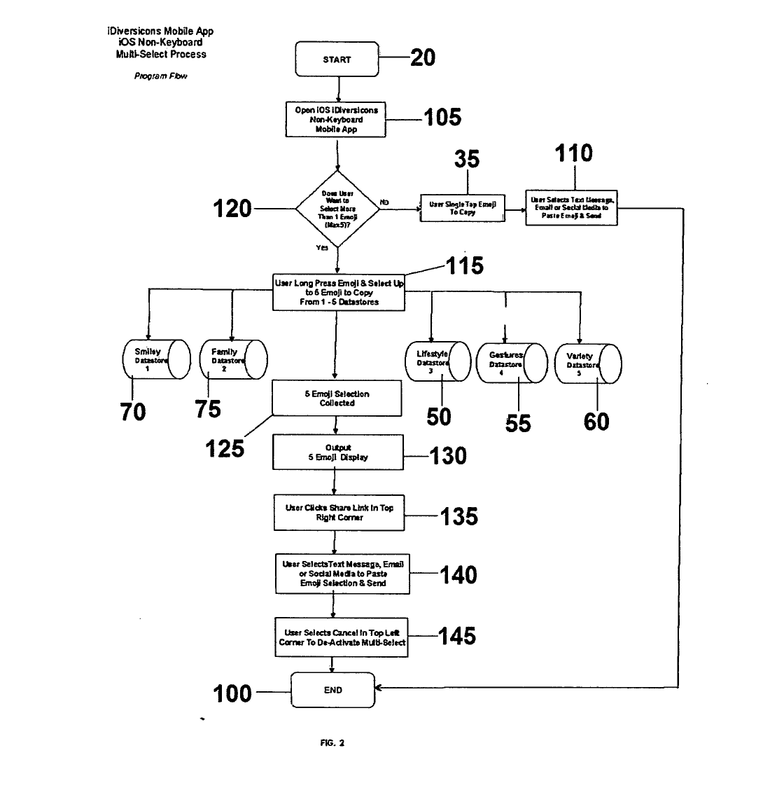

Referring to FIGS. 2 and 2a, there is shown the multi-select process and user interface flow for the IOS. At step 105, the user opens the user interface of the mobile application stored on the mobile device wherein the emojis/emoticons are displayed thereon. At step 120, the user determines whether to select multiple emojis/emoticons. At step 115, the user selects up to 5 emojis/emoticons utilizing a long press to select each emoji/emoticon. The top user interface displays to the user the family category. Once the user selects a family category, the user is provided the option of selecting the ethnicity physical features and then skin tone of selected emojis/emoticons as illustrated above.

At step 125, the collected skin tone and ethnicity are stored temporarily. Utilizing the user interface, the collected emojis/emoticons are outputted to the display at step 130. At step 135, the user clicks the share link in the right corner to select a conventional mode of transmission between text messaging, social media, or email communication. At step 140, the collected emojis/emoticons are submitted by text messaging, social media or email communications. At step 145, the user selects cancel in top left corner to de-activate the multi-select mode. At step 35, if the user only wants to send one emoji/emoticon, the emoji/emoticon is collected and then transmitted at step 110.

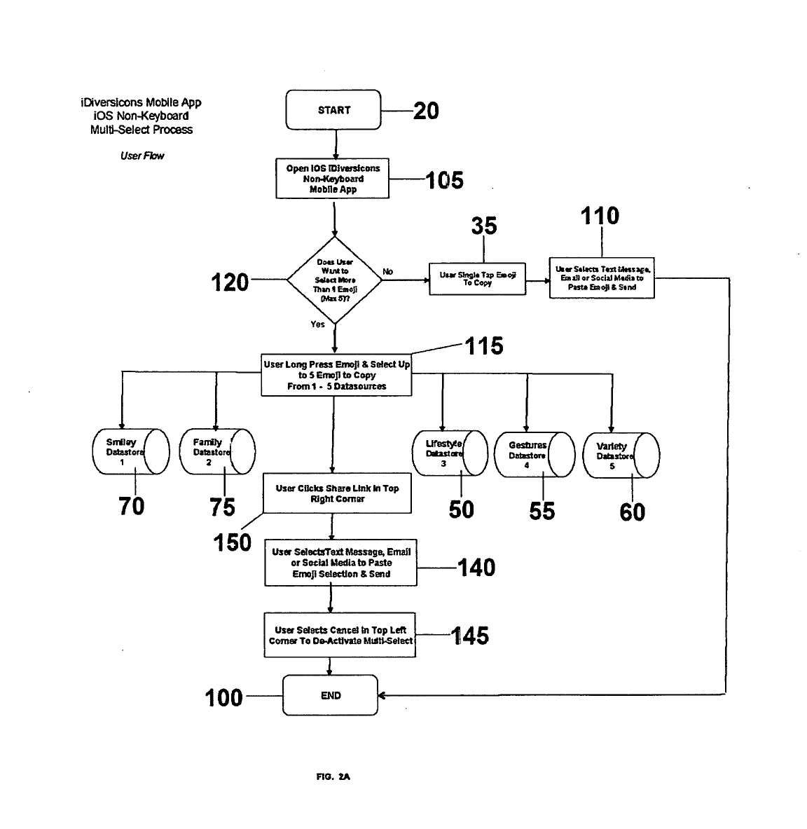

Referring to FIGS. 3 and 3a, there is shown the horizontal display for the IOS system. At step 20, the user opens the user interface of the mobile application stored on the mobile device wherein the emojis/emoticons are displayed thereon. At step 160, the user determines whether to select to display multiple emojis/emoticons in a horizontal order. At step 25, the user selects multiple emojis/emoticons utilizing a software keyboard interface. The user interface displays to the user the family category. Once the user selects a family category, the user is provided the option of selecting the ethnic and skin tone as stated above. At step 155, the collected ethnicity and skin tone are stored in a temporary buffer. Utilizing the user interface, the collected emojis/emoticons are outputted to the display at step 85. At step 90, the collected emojis/emoticons are submitted by text messaging or email. At step 95, the user double taps the screen to de-activate multi-select. At step 30, if the user only wants to send one emoji/emoticon, the emoji/emoticon is collected and then transmitted at step 40.

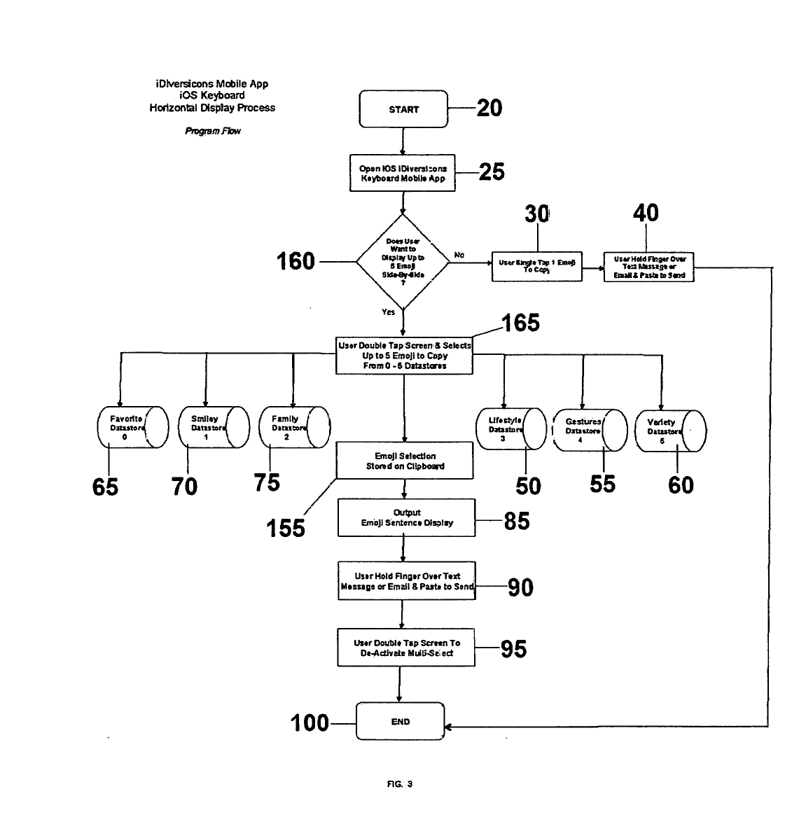

Referring to FIGS. 4 and 4a, there is shown the multi-select process and user interface flow for the Android mobile device. At step 20, the user opens the user interface of the mobile application stored on the mobile device wherein the emojis/emoticons are displayed thereon. At step 120, the user determines whether to select to display multiple emojis/emoticons with a maximum of 5 selections. At step 170, the user opens the user interface of the mobile application stored on the mobile device wherein the emojis/emoticons are displayed thereon. The user interface displays to the user the family category. Once the user selects a family category, the user is provided the option of selecting the ethnic and skin tone as stated above. At step 180, the collected ethnicity and skin tone are stored on an external storage device. At step 185, the user goes to gallery to select and retrieve multiple emojis/emoticons. At step 110, the collected emojis/emoticons are submitted by text messaging or email. At step 95, the user double taps the screen to de-activate multi-select. At step 35, if the user only wants to send one emoji/emoticon, the emoji/emoticon is collected and then transmitted at step 100.

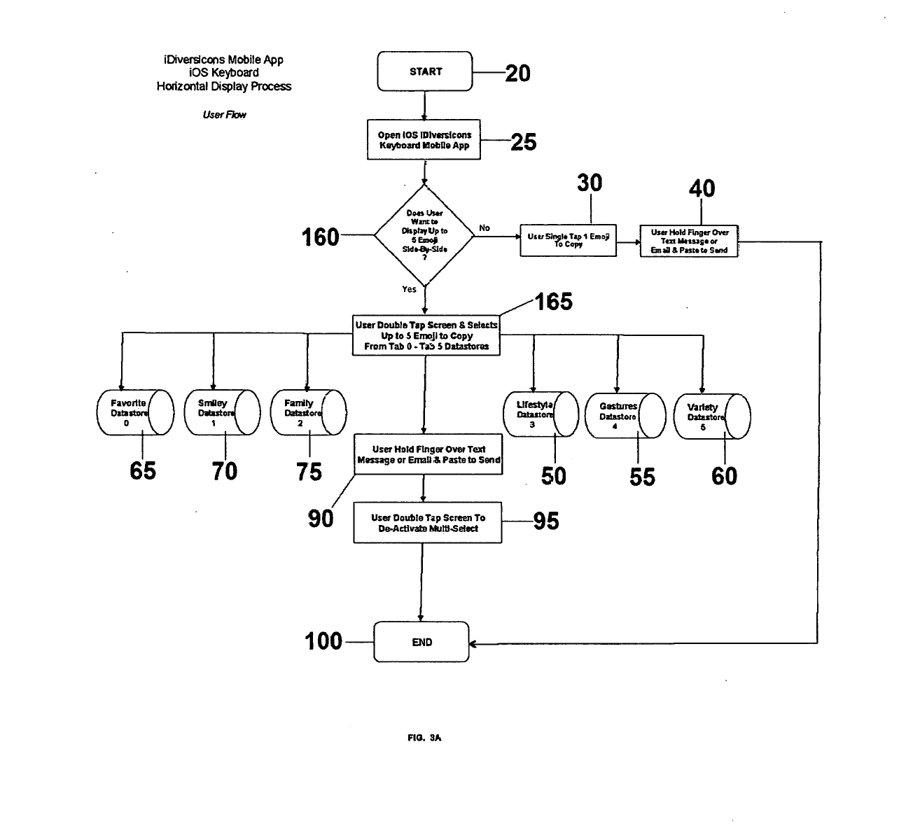

Referring to FIGS. 5 and 5a, there is shown the multi-select process as well as the horizontal display process and user interface flow for the Windows mobile device. At step 20, the user opens the user interface of the mobile application stored on the mobile device wherein the emojis/emoticons are displayed thereon. At step 195, the user determines whether to select to display multiple emojis/emoticons in a horizontal order. At step 190, the user opens the user interface of the mobile application stored on the mobile device wherein a group of ethnic emojis/emoticons are displayed thereon. The user interface displays to the user the family category. Once the user selects a family category, the user is provided the option of selecting the ethnic physical features and skin tone selection as stated above. At step 200, the user double taps the screen of the smart phone to activate/deactivate the capability of selecting multiple emojis/emoticons to copy from the physical ethnic data stores or databases. At step 210, the selected ethnicity and skin tone are collected. Utilizing the user interface, the collected emojis/emoticons are horizontally display at step 215. At step 225, the collected emojis/emoticons are submitted by text messaging, social media or email communications. At step 220, the user double taps the screen to de-activate horizontal display feature. At step 25, if the user only wants to send one emoji/emoticon, the emoji/emoticon is collected and then transmitted at step 110.

What is claimed is:

1. A method of transmitting emojis/emoticons with diverse ethnic physical features in messages from a mobile device:
(a) storing a plurality of predefined emoji/emoticon images representing a plurality of diverse ethnic background in a physical database;
(b) displaying a selected ethnic group of images from the physical database onto a display screen of the mobile device;
(c) displaying a predetermined selection of skin tones onto a display screen of the mobile device;
(d) displaying an actuator through a user interface for a user to capture a selected diverse ethnic emoji/emoticon;
(e) collecting the selected diverse ethnic emoji/emoticon into a buffer memory storage area wherein a diverse emoji/emoticon sentence is created;
(f) repeating steps b-e
(g) incorporating the diverse emoji/emoticon sentence into a buffer message; and
(h) transmitting the buffer message to one or many devices utilizing a transmission protocol.

2. The method of claim 1 wherein the displaying the selected ethnic group further comprises displaying an emoji/emoticon from the group consisting of African-American and Asian, Latino/Hispanic, Indian, Caucasian and Biracial.

3. The method of claim 1 wherein displaying the selected ethnic group further comprises displaying the selected ethnic group onto a simulated keyboard interface.

4. The method of claim 1 further comprising:
utilizing software interface, activating a multi-select option;
selecting at least one diverse emoji/emoticon storing the emoji/emoticon in a message buffer; and
transmitting the message buffer to an end user.

5. The method of claim 1 further comprising:
accepting input of an emoji/emoticon from an end user;
vertically displaying the emoji/emoticon onto the mobile device;
placing emoji/emoticon into a message buffer;
repeating step a-b until the end user selection an emoticon sentence is created;
sizing a horizontal container to accommodate the emoticon sentence;
displaying the horizontal container on the mobile device;

6. The method of claim 1 wherein displaying the predetermined skin tones further comprises displaying a skin tone from the group consisting of ivory, toffee, chocolate, olive, bronze.

7. A system of transmitting emojis/emoticons with diverse ethnic physical features in messages from a mobile device:
(a) means for storing a plurality of predefined emoji/emoticon images representing a plurality of diverse ethnic background in a physical database;
(b) means for displaying a selected ethnic group of images from the physical database onto a display screen of the mobile device;
(c) means for displaying a predetermined selection of skin tones onto a display screen of the mobile device;
(d) means for displaying an actuator through a user interface for a user to capture a selected diverse ethnic emoji/emoticon;
(e) means for collecting the selected diverse ethnic emoji/emoticon into a buffer memory storage area wherein a diverse emoji/emoticon sentence is created;
(f) repeating steps b-e
(g) means for incorporating the diverse emoji/emoticon sentence into a buffer message; and
(h) means for transmitting the buffer message to one or many devices utilizing a transmission protocol.
